(19) United States
(12) Patent Application Publication
(10) Pub. No.: US 2010/0179916 A1
(43) Pub. Date: Jul. 15, 2010

(54) CAREER MANAGEMENT SYSTEM

(76) Inventors: Tammy JOHNS, Etobicoke (CA); Cheryl ATKINS, Milwaukee, WI (US); Amy BERNSTEIN, San Francisco, CA (US); Jill BIESZK, Milwaukee, WI (US); Scott BRZENK, Milwaukee, WI (US); James DAVIDSON, Milwaukee, WI (US); Shelly FUNDEBURG, Columbus, OH (US); Linda PELEJ, Milwaukee, WI (US); Jonas PRISING, Mequon, WI (US); Tony SANTORA, Avon, OH (US); Emma VAN ROOYEN, Ft. Lauderdale, FL (US)

Correspondence Address: IPHORGAN, LTD., 1130 LAKE COOK ROAD, SUITE 240, BUFFALO GROVE, IL, 60089, US

(21) Appl. No.: 12/688,592

(22) Filed: Jan. 15, 2010

Related U.S. Application Data
(60) Provisional application No. 61/205,093, filed on Jan. 15, 2009.

(51) Int. Cl. G06Q 99/00; G06F 15/16

(52) U.S. Cl. 705/319; 709/204

(57) ABSTRACT

The present invention relates to a career management system comprising a module enabling the user of the system to prepare a career profile and comprising a processor enabling the system to learn and provide targeted information to the user and to link the user with other users and user groups. The career management system is software-based and enables the user to communicate with the system and with other users via a computer network.

### CROSS-REFERENCE TO RELATED APPLICATIONS

This application claims the benefit of U.S. Provisional Patent Appl. Ser. No. 61/205,093 filed on Jan. 15, 2009, the contents of which are hereby incorporated by reference.

### FIELD OF THE INVENTION

The present invention relates to a career management system and more particularly to a computer-based career management system whereby the user of the system prepares a career profile and the system learns and provides targeted information to the user and links the user with other users and user groups. All of the above information is served to the user based on information learned about the user through their profile, site use, and broader Internet behavior.

### BACKGROUND

The present inventive system is a career management system initially targeting professionals in the IT, Engineering and Finance & Accounting (F&A) disciplines that aims to change the way people view and manage their careers. While the system is intended to target certain professions, it is designed to accommodate a broader occupation set. Using web 2.0 technologies, the present inventive system brings together career guidance, tools and communities that enable users to understand and plan their careers.

The market drivers behind the development of the present inventive system include recognition that global talent markets are operating within an unpredictable supply and demand balance. Career tracks and job descriptions that were once clear and “guaranteed” by a university degree or past experience can suddenly become low-value or non-existent, leaving individuals to reconstruct themselves and their work life, without relevant navigational resources to guide them on their journey. As power shifts from employers to individuals, even the most insightful and career-savvy individuals struggle with what to do next, let alone dare to create a vision with any depth or longevity. In short, career management has been “outsourced” to its owner: the Individual.

While most online career resources focus only on job search and people in transition, the present inventive system is designed to help individuals make the best decisions over the course of their work life—from assessing their interests and strengths to finding a job and balancing work/life. The platform's community, content and tools leverage Manpower's unique assets by providing access that:
Helps professionals visualize and actively manage their careers based on whatever vision they have for their life and their career.
Provides practical, trusted, engaging careering content and advice from multiple sources of expertise, to enable informed choices.
Connects professionals to a network of peers and mentors with similar interests, on similar career journeys.
Personalizes the experience, content and user connections specifically for them based on their individual needs and behaviors.

### BRIEF DESCRIPTION OF THE DRAWINGS

FIG. 1 is a diagram showing the hardware components used in one embodiment of the present inventive system;

FIGS. 2(a)-(h) show flow diagrams of the present inventive system;

FIG. 3 shows a flow diagram of a feature of the present inventive system;

FIG. 4 shows a flow diagram of a feature of the present inventive system;

FIG. 5 shows a flow diagram of a feature of the present inventive system;

FIGS. 6(a)-(r) show computer generated screen shots of the present inventive system.

### DETAILED DESCRIPTION OF THE DRAWINGS

The present inventive career management system is targeted to be a Web 2.0-based system. The term “Web 2.0” describes the changing trends in the use of World Wide Web technology and web design that aim to enhance creativity, communications, secure information sharing, collaboration and functionality of the web. Web 2.0 concepts have led to the development and evolution of web culture communities and hosted services, such as social-networking sites, video sharing sites, wikis, blogs, and folksonomies. The components noted previously as well as the ability to rate, tag, and comment on the content and components of the site, will further drive usage, collaboration, and viral growth of the system.

The social community aspect of the system includes blogs, forums, polls, and profile information implemented. These features are implemented in such a way that the users will have as much of a seamless user experience as possible regardless of the location within system and the community is pervasive across the entire system. For example, a user will have a similar experience viewing content such as articles, etc. to when the user is reading and responding to a blog or forum. The user will also have the ability to rate and tag content in throughout the site and see how others are viewing and rating the same content. This functionality will drive a number of features that will be served in the site, one of which is the knowledge engine which will drive connections (peers, mentors, mentees), search, serving of content, and others as the site matures.

Additional features of the present inventive career management system include, but are not limited to: Networking (Friending) and being able to establish a personal network, fully integrated search and browsing with the rest of the system, Wiki's, surveys, recommending connections (based on users work history, demographics, industry of interests), folksonomy, groups, social bookmaking (digg, delicious, etc), recognition/reward of users, and badging. Users will also be presented with various career paths to select from and tailor.

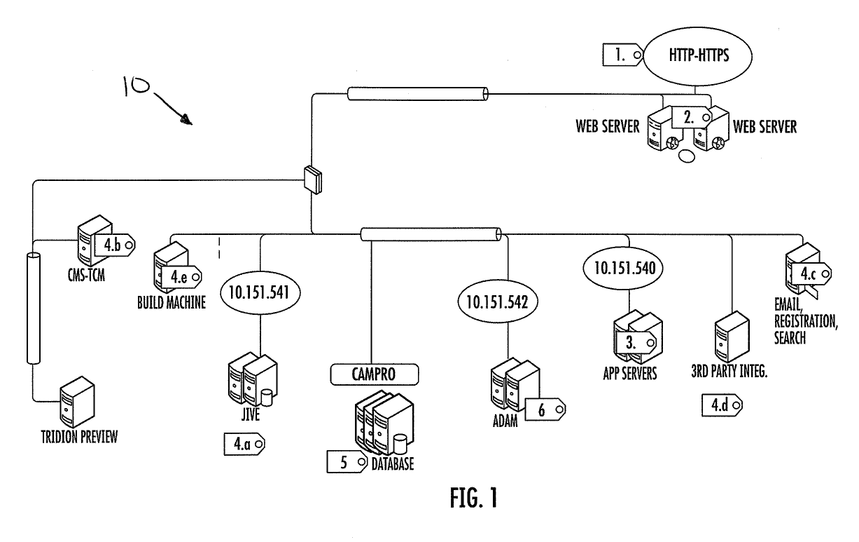

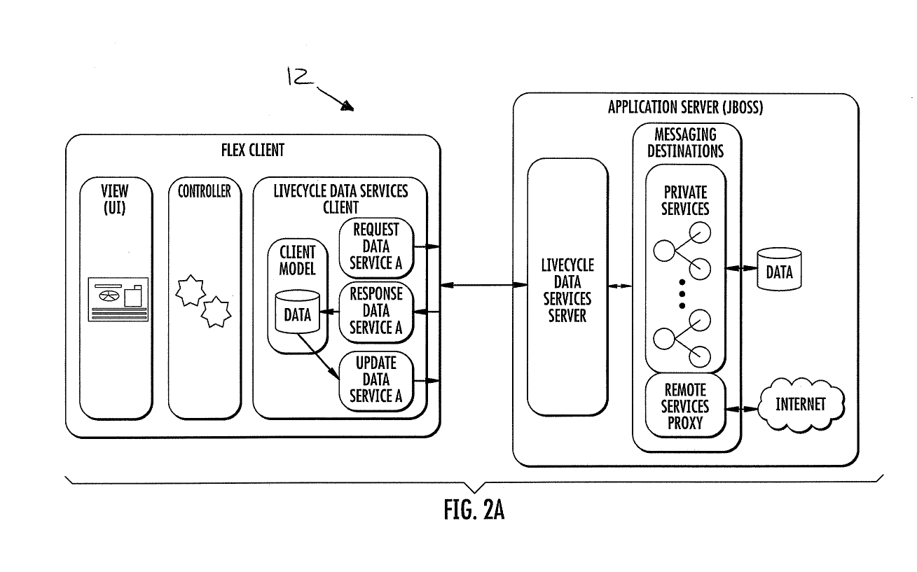

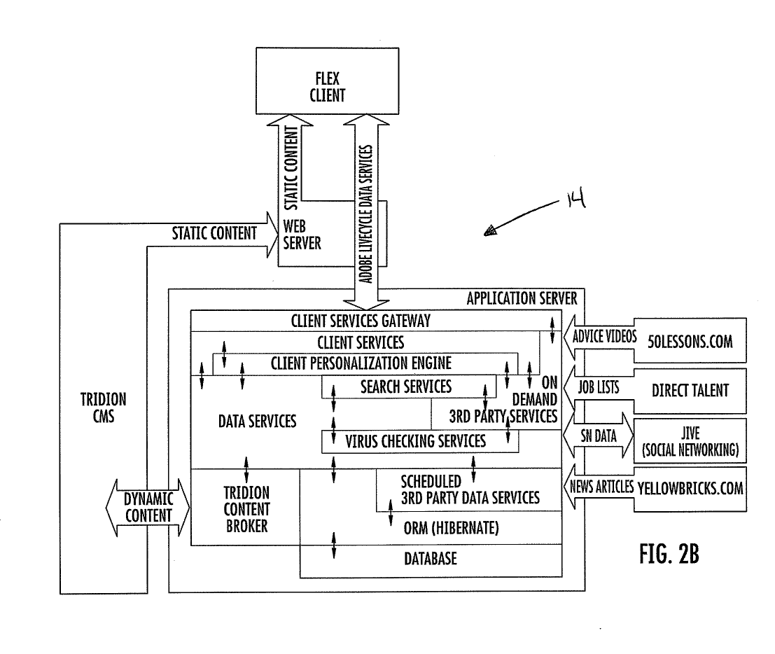

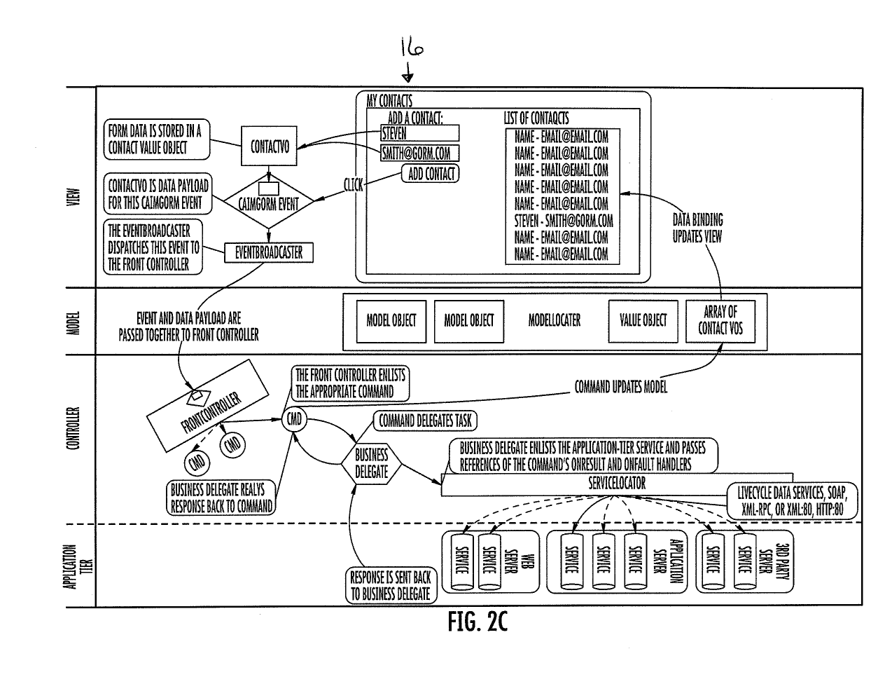

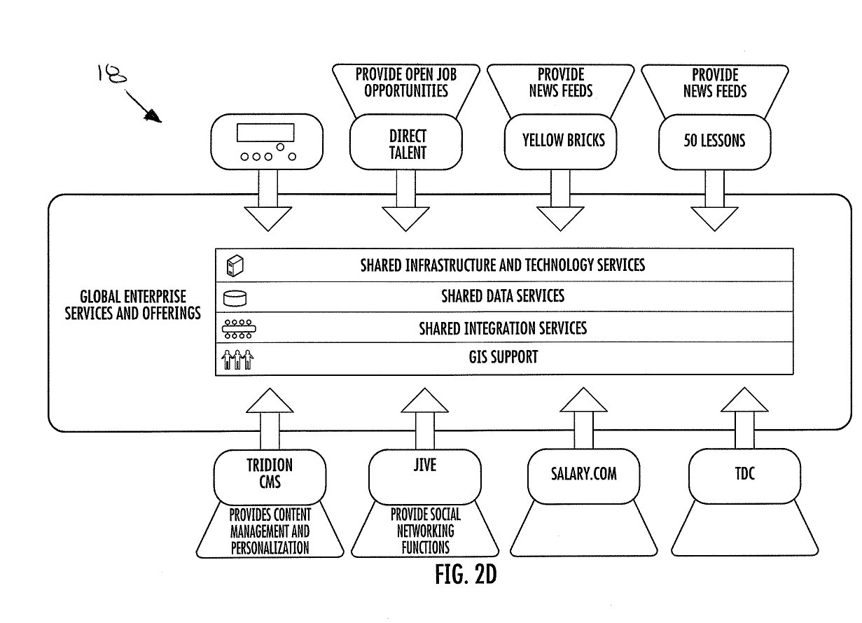

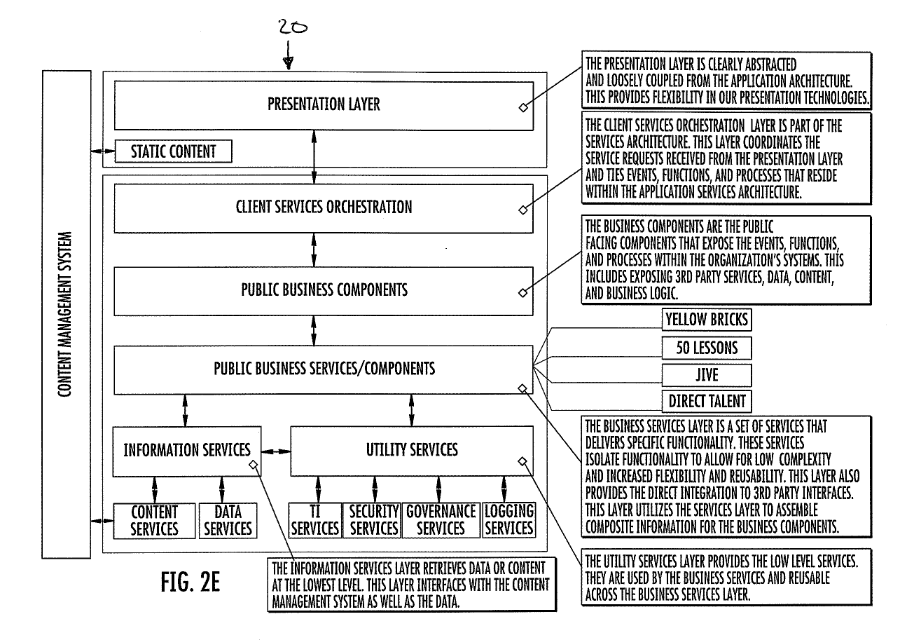

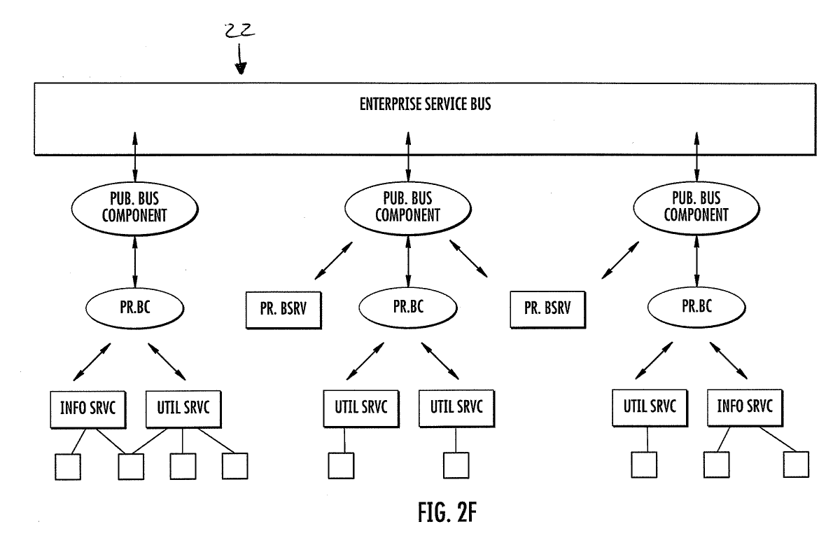

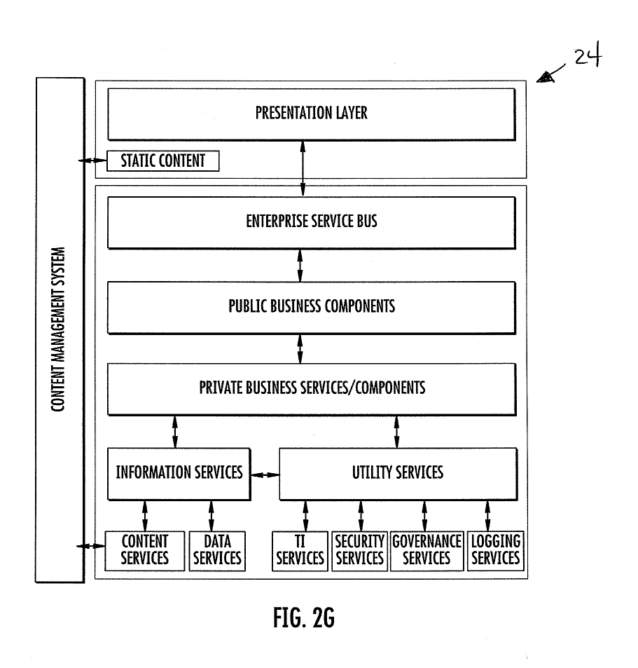

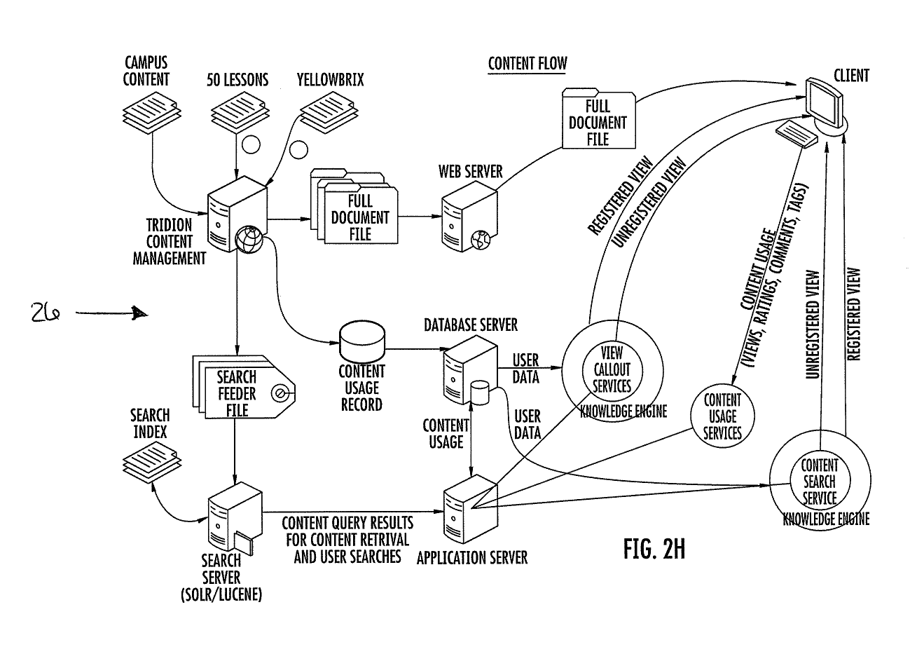

FIG. 1 shows a conceptual diagram of the hardware 10 used in the present inventive career management system and FIGS. 2(a)-2(h) show a conceptual diagram of the processes 12, 14, 16, 18, 20, 22, 24, 26 of the present inventive career management system.

The present inventive system uses the following servers in the described capacity (see drawing for example):

1. F5 Networks—Load balancer

HTTP requests come in and are balanced between the web layer. The web client and the F5 communicates via http for all requests EXCEPT for login traffic which is https.

2. Apache Web servers

Apache: forwarding requests to the application layer (proper) servers.

jBoss: receiving content from gsd1w026s Tridion.

3. Application servers Proper

The two application servers provide the system experience delivered by swf, then communicate with Jive App servers and return an authentication cookie to the browser.

4. Application Servers—The following other auxiliary servers provide the listed function:

Established Products:
a. Jive: Social Networking/Bulletin board/Blog Integrates in to the system and is logged in via cookie once user authenticates.
b. Tridion: Content management—delivering news feeds and business created articles to the web servers.

Developed in House:
c. Email/Search server—using jboss and solr for serving tailored content and use as an outbound email utility.
d. Integration server—used for 3rd party external communication and authorization.
e. Build server—used for code deployment (not part of the functional data stream)

5. Database servers—Oracle

3 servers clustered for hardware resilience—ORACLE 10g R2 with Real Application Clusters (RAC) Used for MyPath proper profile data, Tridion content data, and Jive data.

6. Authentication servers

2 servers using Microsoft Active Directory Authentication Mode for user registrations and authentication using LDAP.

Hardware: IBM x3655, CPU: 2, Type: Dual Core, Effective CPU cores: 4

Memory

Web servers: 5 GB

Application/Database: 16 GB

Database on SAN storage via HBA

The following description addresses the various features and modules of the present inventive career management system:

### I. Core Principles and Features

The core principles and features of the present inventive system include the following:

| | |
|---|---|
| Messaging | The Messaging Component covers the system and |
| | corporate messages that the system operator needs to |
| | publish and make available to system users and |
| | visitors |
| MyTools | MyTools (a.k.a. Stash or Stack) provides but is not |
| | limited to the following: easy access to a system |
| | user's saved and recommended content and incomplete |
| | assessments, maps etc. MyTools should provide a |
| | mechanism for bookmaking content as well as provide |
| | calls to action for recommended content or |
| | activities. |
| Assessments | System is organized around three key ideas: Articles |
| and Tools | and Resources, Assessments and Tools, and Community. |
| | The Assessment and Tools section contains the user's |
| | Career Map and associated content, career |
| | assessments, job search tool, salary comparison tool |
| | and other tools. |
| Articles and | One of the system's key sections, the Articles and |
| Resources | Resources section serves up content relevant to the |
| | end user. The Articles and Resources Section acts as |
| | a Trusted Advisor, guiding the user through Career |
| | Management topics and issues relevant to them based |
| | on their mindset and what the system learns about |
| | the user through their profile, Career Interests |
| | and other assessments. |
| Community | The Community aspect is the heart of the system's |
| | Social Networking. It is the primary vehicle for |
| | user generated content and the place system members |
| | will go to find and connect with other members of |
| | the system. |
| Home Page | The prime landing page for the system. Provides a |
| | sampling of what the system offers to the |
| | unregistered user as well as providing insight into |
| | new and relevant content to registered users. |
| Search | Search allows the user to look for content related |
| | to the topics they are interested in. |
| Content | One of the system's key attributes is its ability to |
| Viewing | serve up relevant content around the topic of Career |
| | Management and Careering to the end user. |

1. Messaging

The Messaging Component covers the system and corporate messages the system operator needs to publish and make available to system users and visitors. The following are the operating parameters for this component:
Key Messages are readily available from all areas of the site.
Key Messages are consistently placed for user familiarity and visual context.
Specific Key Messages (i.e. Data Privacy, Terms of Use) require active consent by the user when registering for the system.
   Changes to any Key Messages need to be actively (i.e. via e-mail or the system's internal messaging system) communicated to the users.

2. MyTools

MyTools (a.k.a. Stash or Stack) provides easy access to a system user's saved and recommended content. MyTools provides a mechanism for bookmaking content as well as provide calls to action for recommended content or activities. The following are the business requirements for this component:
MyTools provides the ability for the user to bookmark content.
MyTools alerts the user if they have any outstanding actions, messages, or invitations.
MyTools is expandable or collapsible at the user's discretion.
MyTools provides a quick link to the user's profile(s).
MyTools provides an ability for the user to add and store other links and toolsets that the user is interested in.

3. Assessments and Tools

Assessments and Tools contains job tools, assessment tools and the user's Career Map and associated content. The Assessments and Tools introduces the user to the concepts of Career Pathing and Career Maps. It persuades and engages the user to actively manage their career. The following are the business requirements for Assessments and Tools:
introduces and educates the user about the concept of a Career Map.
contains examples of a Career Map and showcase famous Career Map's as an example of how a Career Map can function.
educates a user on the importance of actively managing their Career Path. This section needs to sell the user on the importance of active Career Management.
educates the user on how to create and manage their Career Map. It describes the different views available (i.e. Map versus Passport) and instructs the user on not only how to create a Career Map, but the data privacy implications in making a Career Map public.
illustrates growth in the community. It showcases new Career Maps, total Career Maps, and spotlight new or interesting Career Maps.
   Also contained in the Assessments and Tools are the following tools:
Career Assessments
Career Navigator Tool—The Career Navigator is a tool that captures the priorities of the user in relation to his/her career and feeds that to the Knowledge Engine (KE). The KE helps determine the content that will be served to users based on the information provided by the user.
Salary Gauge—Salary data is preferably provided by Salary.com. The system provides a unique tool to allow the user to compare and contrast salaries and perform cost of living comparisons across jobs and/or careers.
Job Watcher—The Job Watcher tool allows the user to search for jobs and save these searches as job agents. The tool is designed to take job feeds from multiple data sources.
Personalized Content Delivery (Serve not Search)—The system will gather information and learn about the registered user based on assessments completed, tags used, Discipline selected, rating of content, and behavior on the site to serve relevant and the most appropriate content based on the user's profile.

4. Articles and Resources

Articles and Resources serves up content relevant to the end user. Articles and Resources acts as a Trusted Advisor guiding a user through Career Management topics and issues relevant to them based on their mindset and what the system learns about the user through their profile, Career Interest (CI) and other inputs.

The following are the business requirements for Articles and Resources:
serves up content that is relevant to the end user. Articles and Resources showcases content that a user should find important and relevant to them.
coaches the user through identifying their Career Management needs.
recognizes that there is a hierarchy of Career Management needs and aids the user when it comes to understanding what their Career Mindset is.
   Articles and Resources has the following five mindsets:
      (1) Find a Job, (2) Balance Work and Life, (3) Find Out Where I'm At, (4) What Else Can I Do?, and (5) Be Better At What I Do

Each mindset must offer content, tools and activities that make the mindsets distinct from one another. The mindsets can be changed and customized by the end user.

Articles and Resources along with each mindset continually engage the end user compelling them to return to the site. New content and tools must be continually surfaced to provide users reasons to return to the system and continue their careering adventure.

5. Community

Community is the heart of the system. It is the primary vehicle for user generated content and the place system members go to find and connect with other members.

The business requirements for the Community are:
Blogs:
   1. List and highlight Blogs available within the system.
   2. Provide a Blog Roll showing a list of blogs and their description.
   3. Provide detailed information on the authors of our blogs, their background and expertise. Authors can include their contact information (i.e. e-mail) at their discretion. The authors should be able to maintain their information directly.
   4. Showcase activity. Highlight new blog posts, active blogs, comments, and prominent links.
   5. Allow bloggers the ability to create a poll and poll their readers.
   6. Allow users to see base information about the users commenting on the blog.
   7. Do not allow anonymous commenting. A user must be a registered and logged in user of the system to comment on a blog entry.
   8. Allow tagging and rating of blog entries, blog comments and blog authors. This information is used to feed our Knowledge Engine
Discussion Forums:
   1. List and highlight the Discussion Forums available within the system.
   2. Provide a description of each Discussion Forum.
   3. Identify the Discussion Forums moderators and key contributors.
   4. Showcase activity. Highlight popular threads and quantify posts.
   5. Assist the moderators in identifying potentially inappropriate content and block users if necessary.
   6. Allow users to see base information about the authors of the discussion thread.
   7. Allow tagging and rating of entries, comments and authors. This information is used to feed our Knowledge Engine
Community Section General Functionality:
   1. Community statistics are served up to show the size and growth of the community.
   2. A user can rate content authored by the community.
   3. A user can tag content authored by the community.
   4. A user can view a tag cloud of popular keywords and drill into entries that use those key words.
   5. A user can search for user generated content.
   6. A user can social bookmark via Del.i.cious, Digg, and Technorati a blog, blog entry or discussion forum.
   7. A user can send a piece of content to a friend via e-mail.
   8. A user can link to a specific blog entry of discussion forum thread with a deep link
Friending.
Mentoring.
Wikis

6. Home Page

The Home Page is the prime landing page for present inventive system. It provides a sampling of what system offers to the unregistered user as well as providing insight into new and relevant content to registered users. The Home Page operates in accordance with the following parameters:
The Home Page is fresh and engaging. It regularly changes by serving up new content, showcasing key content, and illustrating activity within system.
For the unregistered user, the purpose of the Home. Page is to educate them on the system and entice them to register.
For the registered user, the purpose of the Home Page is to show them the activity that has occurred since their last visit and prompt them to explore and engage within the system.

7. Search

The search functionality will have basic search facility using keywords as input. The search results will be ordered based on relevance determined by the already available algorithm in open source Lucene/Solr. Additionally it will allow the user to filter/narrow the search results based on some predefined parameters. The search shall return links to the content, data, people, activity etc.

8. Content Viewing

One of the system's key attributes is its ability to serve up relevant content around the topic of Career Management and Careering to the end user. The business requirements around content viewing and browsing are as follows:
A user can browse content by category, author, and key word.
A user can rate content
A user can tag content.
A user can view a tag cloud of popular keywords and drill into entries that use those key words.
A user can social bookmark via Del.i.cious, Digg, and Technorati a specific piece of content.
A user can comment on a piece of content.
A user can send a link to a piece of content via e-mail to a friend.
A user can print an article or save it to a pdf.
A user can readily find similar articles by topic or rating.
The content viewer can accommodate articles of a variety of length.
Content authors can control the layout of their content, formatting, and inclusion of images.
The content will be ordered based on user profile attributes and behavior.

### II. User Registration

The Registration Process encompasses the process involved in collecting information as part of the account details. Registration is a one-step process in which the system is collecting some basic information about the user that is mandatory to create the account. As part of the registration process, the user will be mandated to view the privacy policy and terms of use and provide acceptance before proceeding with the rest of the process.

1. Feature Elements

1.1 Create and Verify

The user has clicked on ‘Create and Verify’ from one of the numerous locations on the site and navigated to the registration process. There is a link to ‘Sign In’ provided in the same page, in case the user has selected the option ‘Create and Verify’ inadvertently. The various steps involved in creating the account are detailed below.

1.1.1 Create Login

1.1.1.1 The e-mail address will be the login id and serve as the primary e-mail address where all communication from system will be sent.

1.1.1.2 As part of creating a login id, the user will be prompted to enter a valid e-mail address, password and re-enter password for confirmation. There is inline validation of the format of e-mail address and password.

1.1.1.3 Though the user will have an option to add a maximum of 10 secondary e-mail addresses, it will be an option provided as part of account maintenance and not during registration.

1.1.2 Add Basic Profile information

As part of the registration process, basic information about the user that includes the first name, last name, postal code, discipline and industry are collected. This information is mandatory in the account creation process. This is the first information used to start serving content information that is relevant to them.

1.1.3 Accept Terms

1.1.3.1 The user acceptance to the Privacy Notice and Terms of Use is mandatory for account creation. The user will be asked to accept the Privacy Policy and Terms of Use.

1.1.3.2 If the user does not accept to the terms of the privacy notice, the registration process cannot continue.

1.1.3.3 The Terms of Use and Privacy Policy are also provided as a link on the site, to provide the user access to the policies and terms of use at any instance while at the site.

1.1.3.4 The Terms of Use may include notes about disclaimers, legal notices, security notice and other information that will be further defined by the business.

1.1.5 Create Account

1.1.5.1 On clicking ‘Create Account’ after providing the relevant information, the account is saved and a validation e-mail containing a secure link to confirm the e-mail address is sent to the primary e-mail address. When the user selects the secure link to confirm the e-mail address, the account is confirmed.

1.1.5.2 If the user fails to validate the e-mail address, he/she will still be able to access information in the site until the expiration period for the secure link.

1.1.5.3 If the user has not validated the e-mail address, he/she cannot proceed with the account creation.

1.1.5.4 If the user tries to sign in when the e-mail address has not been validated, messaging will be displayed to mandate the user to complete the e-mail confirmation process before proceeding.

1.1.5.5. A link to start recreating the profile is provided as an option to the user in case he/she has inadvertently typed the wrong e-mail address during registration.

1.1.5.6 The user is also provided a link to have the activation e-mail re-sent in situations that include, but not limited to system issues or mail received in spam folder that is set to be emptied automatically.

1.2 Add to Profile

This includes information that is collected as part of building the career story for the user and is optional. An option to load the resume is also provided. The intent is to capture enough data to create at least a sketch of the user within the Knowledge Engine. This will allow a basic content service function. This data may be added or revised at a later time through Profile editing function.

1.2.1 More About Self

To provide more personalized information, current employment status, industry or area of interest and Years of Professional Experience are collected. If the user is employed, details about the job title, company at which he/she is employed and years of experience in the current role are gathered.

1.2.2 Add Resume

The user will be provided an option to load resumes in certain formats that include Microsoft Word (.doc), Adobe Systems (PDF), Rich Text Format (.rtf), plain text (.txt), and HTML. The user will be allowed to upload one resume with the maximum size of 2 MB.

If the user does not have a valid resume to load, there could potentially be a resume-building tool available that will be further defined in another feature set. The resume building service will be provided as a separate service in another feature set and not as part of registration.

2. Operating Parameters

This feature operates within the following parameters:

2.1 Create and Verify

2.1.1 System can handle in-line validation at the field level, and display error messages in Flex “bubbles”.

2.1.2 A user can create an account at any point. Prior to account sign up, the user will see default content. Post sign-up, the user will see tailored content.

2.1.3 The account creation process requests a minimum number of fields and an account ID is created.

2.1.4 Validation of the user's e-mail address is a requirement of the registration process.

2.1.5 Answering Security Questions for the purpose of recovering account information is not a requirement.

2.1.6 User name is e-mail address.

2.1.7 Secondary e-mail addresses can be collected as part of the user's account/profile and user's can change designate one as primary (assumes an underlying system generated userID).

2.1.8 Active (hard log-in) is required for account access.

2.1.9 The secure link that is sent to the primary e-mail address for validation will expire after 48 hours.

2.1.10 The user will be allowed to access the tailored content for 48 hours and if he/she fails to validate the e-mail address within that time, the user will be provided access to content available to unregistered users.

2.1.11 After 48 hours, if the user had not validated the e-mail address, the account should be deleted and the user would have to re-register.

2.1.12 The user cannot proceed with registration until he/she has confirmed the e-mail address.

2.3 Accept Terms

2.3.1 Privacy Notice—The Privacy Notice will be quite broad to cover the different regions/countries. The user must accept to this notice before proceeding with creating account.

2.3.2 Terms of Use—The disclaimers, legal notices, security notice, partner and service information will be covered in the Terms of Use as it is believed there is no specific information that needs to be addressed in each of those items. However this may change if there are specifics that need to be displayed.

### III. User Access—Sign In/Sign Out Procedure

The User Access Feature Set is focused on the interactions and behaviors that users will encounter when they engage with Sign In/Sign Out and Password Reminder. The system must be able to recognize three possible user states, which are further defined below, and must provide two options for Global Links which are determined depending on a whether a user is recognized or unrecognized by the system. The User Access is considered a core feature of the system and is critical to the overall site functionality and design.

1. Feature Elements

1.1 Sign In

1.1.1 The user has navigated to system World Wide Web site or otherwise gained network access to the system.

1.1.2 The user flow for this feature set illustrates the sign-in process when the user is coming from a URL, which could be by searching for system name in a search engine, from a published URL or from a bookmark. The point of entry is when the user navigates to the system URL.

1.1.3 Access to System Based on User State: The system is designed to allow for a differentiated user experience based on a user's logged in state. There are two different options for Global Navigation depending on whether the user is in a recognized or unrecognized state. There will be access to site content in either state and the amount of information that can be accessed will be different based on the sign-in state. Unrecognized users will have access to limited content that is available in the general context. Recognized users will have access to more personalized information. The different states are described in detail below.

1.1.3.1 Unrecognized—Not Signed In

This state describes instances in which a user interacting with the system hasn't signed into the system with a username and password, and the system is unable to identify the user/computer based on a previously established cookie (or other state mechanism that is TBD). The user could be a new user to the site or a previous user who has not signed/logged in.

1.1.3.2 Recognized

This state describes the two classifications Not Signed In and Signed In that are elaborated below:

a) Not Signed In (Soft Sign-In)

This state (also known as “soft sign-in”) describes instances in which a user is interacting with the system and hasn't signed in, but the system is able to identify the user/computer based on a previously established cookie or other equivalent state mechanism. Soft sign-in allows access to limited functionality. While in this state, if the user attempts to edit their account information, the entry of password will be required.

b) Signed In (Hard Sign-In)

This log in state (sometimes referred to as “hard-sign-in”) describes instances in which a user is interacting with the system and has successfully signed in. A hard sign-in will be required to edit account information. If the user has created the account, but has not validated the e-mail address and attempts to sign-in, a message will be displayed to let the user know that the account has not been activated as it is important to validate the e-mail address before proceeding any further with profile modification or other steps that require hard sign-in. If the user has failed to receive an activation e-mail due to system issues or the spam folder is set to automatically delete mails, an option to have another activation e-mail is provided.

1.2 Sign-Out

This option is available to Recognized user. When the user clicks on “sign-out” link, the user state is set to Unrecognized—Not Signed In and the display changes to unrecognized view.

1.3 Password Reminders

1.3.1 The user might have forgotten the password and hence is unable to sign-in to the system. The user is provided a link for getting assistance on password and the action depends on the state of the user, which may be, either unrecognized or recognized soft sign-in.

1.3.2 If the user state is unrecognized, the user will be prompted to enter valid e-mail address.

1.3.3 If the user state is in soft sign-in, the e-mail address is populated automatically.

1.3.4 In both the above cases the system shall verify the following:
The format of the e-mail address
The e-mail address exists in the system

1.3.5 Upon successful validation as detailed in 1.3.4, a secure password reset link is sent via e-mail and a confirmation message is displayed.

1.3.6 When the user selects secure link to reset password, the prompt to enter the new password and confirm password is displayed. Upon successful completion of the password change, the users can sign-in to the account.

2. Operating Parameters

This feature operates within the following parameters:

2.1 Multilanguage Capability

Because the system is capable of being deployed in several countries/regions, all screens cater for multi-language capability.

2.2 User Name

2.2.1 The system will use email addresses as user names for authentication. The use of email addresses as user name should not be confused with what can be used as a display/screen name (display/screen names can be collected as part of a user profile separately).

2.3 Email Address Uniqueness/Validation

2.3.1 Email address must be unique.

2.3.2 Email address must be validated/confirmed. The validation of the e-mail address format should cater for different regions/countries.

2.4 Primary/Secondary Email Addresses

2.4.1 Multiple email addresses can be collected as part of the user's account/profile and user can designate one as primary for the purpose of receiving system communications.

2.4.2 A user can change their primary email address at will provided they are changing to a validated/confirmed email address.

2.4.3 There will be a maximum of ten secondary email addresses that a user can associate with their account.

2.5 Sign-In from URL

2.5.1 Site will be able to differentiate recognized and unrecognized users.

2.5.2 Site will set a session variable.

2.5.3 System can handle in-line validation and error display.

2.6 Password Format

The password preferably must have at least 8 characters with at least one letter and one number and is case-sensitive.

2.7 Forgot Password:

The system will be designed to allow for the user to request password assistance. The assistance will come in the form of a secure link for resetting the password via e-mail.
The link will remain active for 48 hours. After 48 hours, the user would need to request another password reset.
The link in the email will take the user to a web form, which will allow the user to create a new password.
   As part of the account sign-up process, e-mail addresses are confirmed and validated.

2.8 Security Questions

Answering security questions for the purpose of recovering account information is not a requirement.

2.9 Sign-Out:

2.9.1 The need for a fail-safe mechanism that will allow the user to return to a screen view or process in case of accidental sign out is not a requirement.

2.9.2 The need for maintaining a suspended state so the user can resume the action or process if he/she chooses to sign back in immediately is not a requirement.

2.9.3 Clicking Sign Out returns the user to the home page (unrecognized view).

2.10 Event Messaging

System can handle in-line validation and error message display.

2.11 State Information

Since the application is RIA, flash cookies will be used that will be stored permanently on the user's computer unless the user chooses not to allot any space for the storage. If the user is in hard sign-in state and there is 4 hours of inactivity, the state will be automatically switched to soft sign-in. If the user is in soft sign-in state and there is 48 hours of inactivity, the state will be automatically switched to unrecognized. The elapsed times (4 & 48 hours) are subject to alteration per needs basis.

### IV. Account Maintenance

The Account Maintenance Feature Set is focused on how the user can make changes or additions to existing personal information in their account. The user is provided links on the left side of the page that are a high level overview of the account and can select the item that needs to be edited. On selecting the link to update the account information, corresponding information is displayed and on selecting the field to edit, the display changes to accommodate the edit. The information that can be maintained as part of the account includes Personal Info and Account Settings, Preferences and Career Assessments.

1. Feature Elements

1.1 Personal Info and Account Settings

1.1.1 The user has done a hard sign-in for editing account and has navigated to View Account.

1.1.2 Every item that can be edited has a link to either view or edit the information.

1.1.3.The option to save the changes or cancel any changes made is available for all account information.

1.1.4 The information that can be edited includes name and location, e-mail addresses, password and photo upload.

1.1.4.1 Name, Location, Discipline and Industry

The user can make changes or add to the name, display name, location, Discipline or Industry.
The display name will be defaulted to the first name and last name.
The user can override the display name to be the first name and last initial.
Any other preferred display name will not be allowed.
The display name will be used whenever the identity of the user is exposed to others that includes blogs/comments, profiles etc.
The user will be greeted in all communications using the first name only.
The user can make multiple industry selection.
The user can make multiple discipline selections.

1.1.4.2 E-Mail Addresses

The user can add/delete secondary e-mail addresses, change the primary e-mail address and modify the kinds of communication that they would like to receive from system.
When the user adds a secondary e-mail address, a link is added to denote the confirmation status of that e-mail address.
Only confirmed secondary e-mail address can be swapped as a primary e-mail address.
The primary e-mail address is the one to which all communication will be sent.

1.1.4.2.1 Add Secondary E-Mail Address
When the user adds a secondary e-mail address, the address is validated and when the user selects the option to add and send confirmation, validation e-mail is sent to the user's primary e-mail address.
The messaging area is updated to indicate the user about the process of the confirmation and the status.
When the user clicks on the secure link to confirm the added secondary e-mail, the login id, which is pre-populated, is displayed and the user will be asked to enter the password to confirm. On entering the correct password, the secondary e-mail is added as a confirmed address.

1.1.4.3 Change Password

An option to change the password is provided.

1.1.4.4 Photo and Avatar

The user is provided an option to upload a photo or change an already loaded photo with a new one. The user can also delete an uploaded photo. The limitations of the file size and the photo formats are from Jive.
The size limit on the photo upload is less than 4 MB.
The file formats for the photo upload are JPG, GIF, PNG, and BMP.
A default avatar is initially selected, but the user can select another choice of avatar from the list of supplied avatars.
The upload button for the photo appears only when the user checks the Rights release box.
There is a default image associated if the user has not uploaded a photo.

1.1.4.5 Bio

A short description that the user had input is stored and displayed here.

1.2 Preferences

The user's preferences with Career Interests and the Notifications that (s)he would like to receive are covered here.

1.2.1 Career Interests

1.2.2 Notifications

The user is provided an option to view and change the communication preferences. The user can subscribe to the following items:
Discussion that (s)he creates
Discussion that (s)he can comment on
Blogs that (s)he can comment on

1.3 Career Assessments

The user can take career assessments that are part of Career Leader. The assessments that the user can take include motivations profile, themes inventory and abilities profile. This is only for maintaining the assessments.

2. Operating Parameters

This feature operates within the following parameters:

2.1 Multilanguage Capability

Because the system is capable of being deployed in several countries/regions, all screens cater for multi-language capability.

2.2 User Name

2.2.1 The system will use email addresses as user names for authentication. The use of email addresses as user name should not be confused with what can be used as a display/screen name (display/screen names can be collected as part of a user account separately).

2.3 Email Address Uniqueness/Validation

2.3.1 Email address must be unique.

2.3.2 Email address must be validated/confirmed. The validation of the e-mail address format should cater for different regions/countries.

2.4 Primary/Secondary Email Addresses

2.4.1 Multiple email addresses can be collected as part of the user's account/profile and user can designate one as primary for the purpose of receiving system communications.

2.4.2 A user can change their primary email address at will provided they are changing to a validated/confirmed email address.

2.4.3 There will be a maximum of ten secondary email addresses that a user can associate with their account.

2.4.4 An additional open issue is whether there is a need/desire to allow the secondary email address (provided they have been validated/confirmed) to also act as a username.

2.5 Password Format

2.5.1 The password preferably has at least 8 characters with at least one letter and one number and is case-sensitive.

2.6 Sign-Out:

2.6.1 The need for a fail-safe mechanism that will allow the user to return to a screen view or process in case of accidental sign out is not a requirement.

2.6.2 The need for maintaining a suspended state so the user can resume the action or process if he/she chooses to sign back in immediately is not a requirement.

2.6.3 Clicking Sign Out returns the user to the home page (unrecognized view).

2.7 Event Messaging

System can handle in-line validation and error message display.

2.8 State Information

2.8.1 Since the application is RIA, flash cookies will be used that will be stored permanently on the user's computer unless the user chooses not to allot any space for the storage.

2.8.2 If the user is in hard sign-in state and there is 4 hours of inactivity, the state will be automatically switched to soft sign-in.

2.8.3 If the user is in soft sign-in state and there is 48 hours of inactivity, the state will be automatically switched to unrecognized. The elapsed times (4 & 48 hours) are subject to alteration per needs basis and should be configurable.

2.9 Expiration of Accounts

The accounts created will reside on the system for a very long time (permanent) and there is no flushing of the accounts after any period of inactivity.

### V. Career Mapping Function

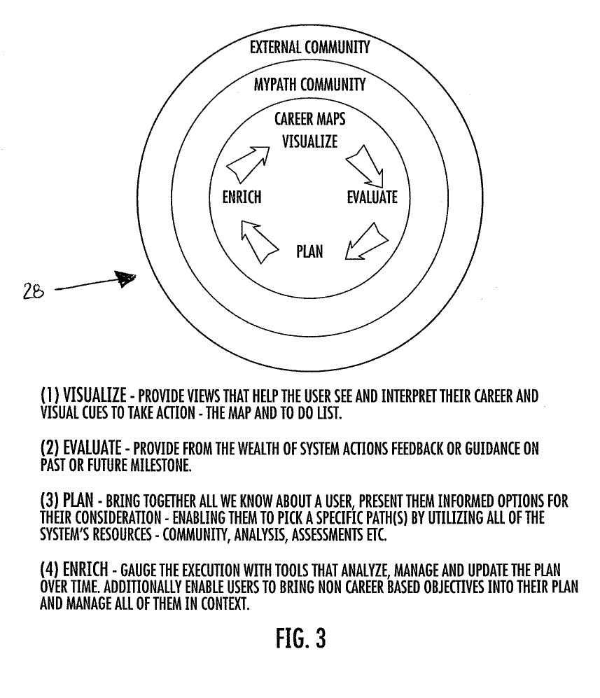

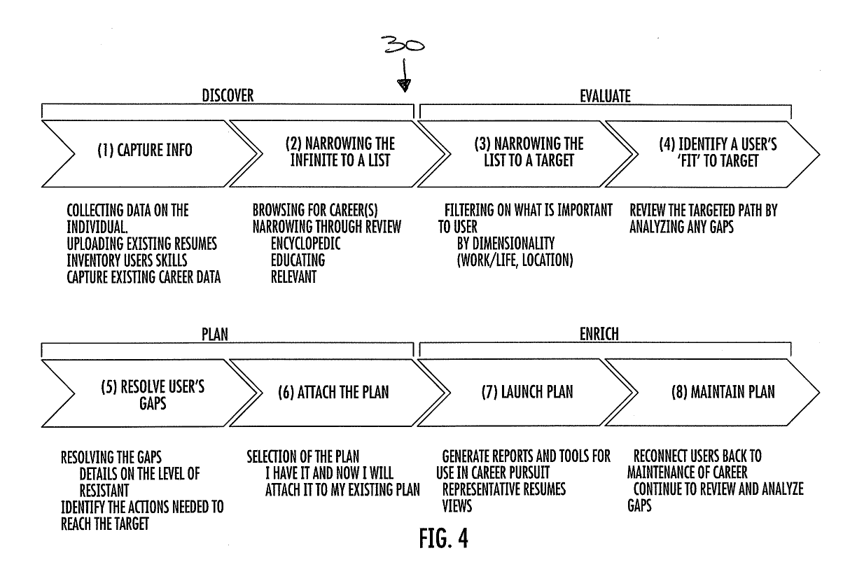

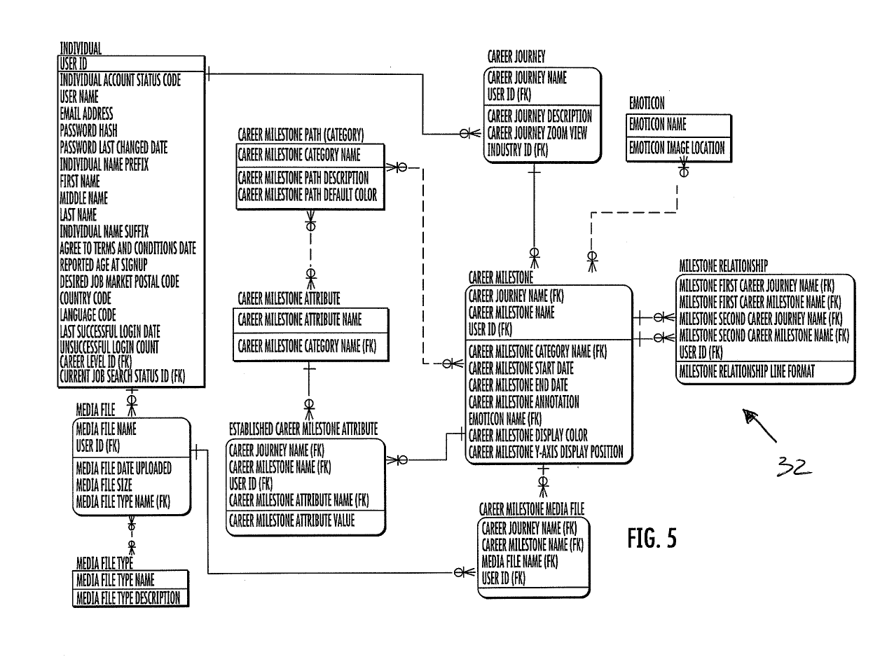

The career map feature of the present inventive system is a set of tools to visualize, evaluate, plan and enrich the experience by leveraging data from the user, the system administrator, external sources and the community of system users.
Visualize: Provide views that help the user see and interpret their career and visual cues to take action—the map and to do list.
Evaluate: Provide from the wealth of system actions feedback or guidance on past or future milestones.
Plan: Bring together all we know about a user, present them informed options for their consideration—enabling them to pick a specific path(s) by utilizing all of the system resources—Community, Analysis, Assessments etc
Enrich: Gauge the execution with tools that analyze, manage and update the plan over time. Additionally enable users to bring non career based objectives into their plan and manage all of them in context.
   The interaction of these concepts 28 is shown in FIG. 3. A conceptual diagram of the career mapping feature 30, 32 is shown in FIGS. 4 and 5.

Traditional resumes are linear and one dimensional. The career mapping function gives system users and the system community a way to reflect on their past and visualize their future. The more system users contribute data the better maps will be for individuals to make informed decisions in their careers. The career mapping function gives users a tool to run different career scenarios to help them realize a career path that fits. The output can be shared with peers, prospective employers, mentors and the system community.

1. Career Mapping Feature Functional Requirements

1.1 Milestones

Milestones are unique containers for information. They are meant to be a visual representation of an event that has occurred. Milestones will be presented on a career map based on the timing of when the milestone occurred. An example of a Milestone is Education.
Milestones will also have attributes associated with them. Attributes provide the unique accomplishment or details around the milestone. For example, the Milestone Education could have attributes of BA-Finance. A milestone of a job would have attributes related to Job Title, Company, etc.

1.1.1 List of Available Milestones with Attributes

Milestones will be generated or create form a pick list (drop-down). The list will contain the following options:
1. Education
   a. Degree
   b. School
2. Job
   a. Company Name
   b. Job Title
   c. Company Size
3. Financial Commitment
   a. House—Year purchased
   b. Medical Insurance—# of years until Medicare
   c. Child going to college
   d. Supporting other Family
   e. Alimony
   f. Others
4. Family/Life Event (inclusive of Child, Marriage, Divorce) Child
   a. Marriage
   b. Divorce
   c. Death of Significant Other
   d. Taking over care of Relative
5. Volunteerism
   a. Organization Name
   b. Role within Organization
6. Relocation
   a. Why
   b. Where
7. Sabbatical
8. Retirement
9. Decision Point—What to do next?

1.2 Creation of Milestones

The system supports the following:

1. Auto-generated based on a resume that was uploaded.
a. The resume will contain a number of milestones related to the person's path. (i.e. education, jobs, volunteer information, other achievements)

2. User Generated Milestones
a. There will be life events or other milestones that are not contained within a resume. The user should be able to create milestones within the career map section and indicate the proper location and duration of that milestone on the map.

1.3 Advanced Milestones

Once milestones have been created, the user may enrich the milestones to provide further benefit to the experience in the system. Enrichment can be links to mentor, satisfaction with milestone, effectiveness, rating of school, company, etc. In the instance where a rating is given, the rating should be presented both in a numeric and graphical representation (icon, i.e. Harvey Balls, etc.) The user should have the ability to set his/her preferences on the display method for the rating.

Milestones related to Life Events (Goals) should stay in the map visualization always ahead of today until completed or removed. These milestones are contextually available when pathing decisions are being evaluated so that they may be inserted at any time and measured.

Milestones will be enriched by the following:
For all milestones:
Dates should be entered for milestones. Allow the user to effective date the milestone either backwards in time or forward (for planned future milestones).
Allow the user to enter text or comments related to each milestone. These will be accessible by the user or other users (if the milestone owner's profile allows) via a double click into the milestone heading or a label called “Comments”.
Allow the user to connect to others with the same milestone and combination of enriched milestones
   For example: Connect me with others that have the same degree from my college, Connect me with others that have the same job title, etc.
   Connect me with others that have followed the same path (2-3 steps behind and forward)
Allow users to connect with people who are looking for or offering to be mentors based on the specific milestones.
Milestone should be color coded to represent why the user had taken that milestone. For example, education is purple
All Milestones should allow the user to identify why the decision was made of the milestone. For example, a milestone for a job could be 50% work-life balance and 50% career path, and for another user, a job decision could have been 100% for training for the next job in the path.
1. Education
   a. School Rank (national/state)—From a national publication on universities. This should be auto-populated for the user
   b. GPA—Allow the user to enter via a link/prompt
   c. Overall School Satisfaction—Added by user (need some type of rating (1-5 with 5 being the highest)
   d. School Degree Satisfaction—Added by user (need some type of rating (1-5 with 5 being the highest)
   e. School Degree Effectiveness—Added by user (need some type of rating (1-5 with 5 being the highest)
2. Job
   a. Fortune 500 Company Rank
   b. Job Title
   c. Company Satisfaction
   d. Job Satisfaction
   e. Job Effectiveness towards goals/path
3. Financial Commitment
   a. Include Date or Date Planned
4. Family/Life Event (inclusive of Child, Marriage, Divorce, same as noted above)
   a. Include Date or Date Planned
5. Volunteerism
   a. Organization Name
   b. Role within Organization
   c. Satisfaction for Life
   d. Correlation to Job/Career
6. Relocation
   a. Satisfaction with Decision
   b. Why the move? (drop down—work, family, legal, etc.)
7. Sabbatical
   a. How Long
   b. Why
   c. Satisfaction with Decision
8. Retirement
   a. When
   b. Satisfaction with Decision
9. Decision Point—What to do next?
   a. Others in your Path or point

As users change their rankings for satisfaction, etc. the system should maintain and audit trial for future possible analysis. Users should be able to enter accomplishments within a milestone. Example, at a particular job, what key accomplishments or achievements can be noted.

1.4 Milestone Linking

Milestones are linked by durations (lines or some type of connector). The Connector should show duration or other necessary information. If a life event had an impact on another milestone, for example, having child made a user take a specific job, allow the user to link one milestone to another as the basis for the decision.

1.5 Current State

Within the career mapping feature, the user's current state needs to be shown. Current state could be reflected by “today's date” and their state could be reflected by: Number of children, current employee, current school, marital status, etc. This could be displayed visually, by text, by a date, etc.

2. Career Map Features and Layouts

The career mapping feature layout is presented visually to the user. Milestones are linked (i.e. lines, etc.) to reflect time and events. The layout also shows a countdown of time (timeline) until the user wants to achieve the path (i.e. number of years until retirement). This timeline could differ based on the user. For example, one person's map may be until retirement, one may be to financial independence, one could be job goal focused.

2.1 Career Map Versioning

The system users should be able to create multiple versions of their map similar to the way people create different versions of their resume. Allow users to create a map and save it.

2.2 Users should have ability to have multiple strains for the same end goal. There may be different ways to achieve the same goal and as such the user should be able to track against them.

3. Impacts to the User's Account

To build and display career mapping feature, necessary information is being captured within a user's account and used by the system. Account details related to the items below are captured in order to properly create output with relative information related to the user. For each of the items below, the career mapping feature will evaluate the selections for jobs, etc. with the profile to identify if the decision is in line with the user stated preferences.
1. Travel Preferences
   a. Provide the user the ability to indicate the percentage of travel he/she is willing to do for work. This percentage should be editable at any time. If the percentage of travel is changed, the profile match shown on a career map should be reflected appropriately based on the new percentage
2. Relocation
   a. Users should be able to identify their wiliness to relocate for work. The user should be provided a range related to mileage for which a radio button can be selected. Mileage ranges should be 0-50 Miles, 50-100 Miles, 101-200 Miles, 201-500 Miles, 500+ Miles
   b. This relocation preference should be editable at any time. Update the career map appropriately based on the change in the profile.
3. Work-Life Balance
   a. The user should be able to show the level of work they are willing to do. For

Example, Part time, Full Time (Assuming 40 hrs), 10% Overtime, 25% Overtime, 50% Overtime. This preference should be displayed to the user in a visual display. Examples could be a sliding scale, etc.
b. The work-life balance preference should be editable at any time. Update the career map appropriately based on the change in the profile.
4. Salary Expectation
   a. Allow the user to enter a salary/earnings goal in their profile. This earnings goal will tie to the next job(s) in the career map an
5. User Characterization
   a. Users should be able to identify their personality type within the site. Identification should be presented to the user based on the self assessment taken through Career Assessment. The presented personality type should be editable by the user.
6. Credentials
   a. Users should be able to represent achievements that are not a defined milestone but may be required for a certain type of job/position.
      i. Examples include: Bar License, Certifications, etc.

3.1 Ability to Hide/Share Milestones and Maps

Users have the ability to opt in or out related to the ability for Search Engines to search for their profile and career maps. Additionally, users should have the ability to set for each individual milestone and/or career map whether it is visible/shared with the following:
Registered users
Non-registered users (general public)
Mentors
Your network
Your Groups

The preference to share profiles, milestones, career maps, etc can be set at the global level but any modifications within the career maps modules will override the global setting of preferences (Profile Views) for that module of the site.

4. Building the Map

Once a user's preferences have been obtained and the user's milestones to date have been collected and presented on the map, the next step is to allow the user to select or set their next step. This can be done manually through a wizard-like process.

5. Connections

Users should have the ability to perform the tasks/and connect with the following;
Ability to send your career map to others via a URL
Be able to search for other user's output
Ability to connect via messaging (if user granted)
Comparison of your map to others.

Users should be provided the ability to connect with others through the entire site including the career maps section. Every place the user is in the system allows the user to connect with others. When others are connecting for the purpose of mentoring or being mentored, the following should apply:
1. Double opt in/out (user and mentor both have to indicate the preference)
2. Mentors/Mentorees can browse the profiles and publicly available info with easy to access “request

The career mapping feature will use Milestones (nodes) for Social Networking interactions. Types of milestones include education, employment, decision points or life event/goals (or any other type of milestone that gets added). Individuals that match a milestone attribute such as employer, degree, etc., will be contextually listed. Selecting (right click or click through) a listed individual will open the complete list of Social Networking options. (peer group interactions)

Milestones should be able to list individuals that have expressed willingness to mentor or be mentored based on milestone attribute. Selecting (right click or click through) a listed individual brings up appropriate mentoring pop-up or screen.

Career Leader Delta Match should be used in order to allow users to connect with others who are like them. The career mapping feature contemplates creating output for the following types of users: I do not know what my next step should be, I have an idea but want to evaluate my options, and I know exactly what I want to do. 5.1 The “I Don't Know User”

When user is not sure of what the next steps should be the user should be presented with the following:
1. Statistics o how many users or imported profiles that match the current job or historical path (current job and 1 to X steps back).
2. A descending list of next step matches that others have taken (which can be filtered or not filtered) based on preferences.
3. Present thee options such that they are able to be tagged by the user and added to the decision point for exploration or bookmarked for future review.

When the aggregate list of next steps is provided, the user should be able to review each of the possible next steps in more detail and analysis in one place. Details provided should include:
1. % of those who followed the same path
2. % of those who were satisfied with the decision made
3. % match to profile that was established by the users
4. Job descriptions and most relevant skills related to the jobs
5. Articles or most relevant content related to the item identified
6. Possible Mentors

5.2 I Want to Evaluate My Options User

For the user who would has an idea but would like to evaluate further, provide the following:
1. Provide same links to the content and social networking options/drill downs as in the “I do not know” view
2. Job effectiveness and Job Satisfaction averages for the roles compared between the options
3. Profile match comparisons for the options (Travel, Work/Life Balance, etc.)
4. Life Events presented for potential consideration (the uncompleted goals in descending order of readiness/skill match)
5. Skill gaps of jobs to current skill inventory
6. Jobs beyond the next step job (what doors does the next role open up)
7. Browse forward into those jobs and repeat the above again (content, comparisons, etc.)

5.3 For the User Who Knows Exactly What They Want to Do

The user should be able to search for the position title(s) within Milestones that he/she wants to pursue. This will allow the user to still be provided some details around the selections related to the data in the site. Once a user selects the next steps, the user should be given the option to perform an analysis against their preferences, etc. Details to provide include:
1. Job effectiveness and Job Satisfaction averages for the roles compared between the options
2. Profile match comparisons for the options (Travel, Work/Life Balance, etc.)
3. Life Events presented for potential consideration (the uncompleted goals in descending order of readiness/skill match)
4. Skill gaps of jobs to current skill inventory

6. Route Review

Once a user has narrowed their selection to a single path, the user should be presented with a route evaluation page to show the user how others achieved their goal.

6.1 Routes for Those Looking to Change Jobs

Routes could include: the fastest, the best match to profile, the most common path based on the community or uploaded resumes.

The user should then be able to select a single route based on the proposed routes. Once a single route has been determined, the following should be shown to the user:
1. Skill/Credential requirements for the job are displayed and matched against the skill inventory of the user
2. Gap list of skills are calculated
3. Path steps to endgame job indicate how many skill gaps will be covered by the path selected
4. “True Gaps” or gaps that will not be addressed by the intermediate steps to endgame (skills not flagged for development along the path) will require side steps in order to qualify will be listed. Sidestep related jobs are offered to be added to the path (same cycle as above)

Users can reorder any steps along the path or modify the standard path (add extra jobs, remove a job, build their own path, etc.)

Path acceptance would then insert the projected path back into the visualization and mapped using average time frames for each step

6.2 Treatment of Those Not Changing Jobs

For users note changing jobs, the user should be presented a skill inventory view to plan skill development within that job. Users should be able to update skill inventory. Skills inventory needs to provide a history of completed skill improvements or a log of when skill inventory changes took place (perhaps with effective dating for changes that are made after the fact).

6.3 Map Overlays

Users should be able to review their routes and paths with different overlays. Overlays will provide the use different views based on their selection. Overlays could be presented as different tabs or views of one route. Overlays should include:
1. Salary/Earnings Expectations against Possible Positions Earnings
2. Profile Matches, Gaps, and Warnings (i.e. too much travel, too little balance, relocation requirements)
3. Skills Required/Skill Gaps

6.4 Alternative Views of the Maps

Since users may approach path management differently, the system provides alternate views. For example, the previous sections discuss looking at the user's jobs, etc. and evaluating what the next positions should be. However, some users may want to provide their interests, etc and skills and have the site propose the best path. The following should be available to users:
1. Skill Inventory and skill tree builds for folks who don't care about the job so much as the accumulation of experience/skills
2. Influence views where perhaps leadership, autonomy, impact or control are used in lieu of skills
3. Assessments may suggest additional views based on basic personality types or approaches (the planner, the spontaneous, the rule minder, the socialite, etc.)

### VI. Serve Not Search Functionality

The present inventive system includes “serve not search” functionality that takes advantage of a unique Knowledge Engine to serve available information (such as data, content, people, etc) to the users of system. The serve not search functionality operates according to the following parameters:
User will provide basic and extended account information (user name and password)
The user will spend time on the site browsing for information and participating in communities.
The system will use this information and behaviors to develop patterns for this and other users that allow similar relevant information to be served to the user.

1. Functional Aspects

Information is organized in such a way that relevancy and usefulness governs which information is served to the users and the order in which it is listed. The aspects of this feature are described as follows:

1.1 Content Repository

This content repository houses content such as articles, videos, yellow brix (news feed) forum and blog. Forum and blog content application is a separate application housed in its own dedicated server.

1.2 Tag Content (Manual)

Content are manually tagged for the relevancy parameters such as discipline, CI parameters and date as detailed in the FSS for “Serve not Search”.

1.3 Tag Content (Automatic)

Automatic tagging feature design is underway. Manual tagging will be replaced with automatic tagging, as it gets developed and ready to integrate. Automatic tagging can be done only for content, which is published in the destined web server as part of the publishing process.

1.4 Publish Content

Content is available for display only after the same is published/hosted in the system web server.

1.5 Viewer-Display Content (Not Personalized)

Content displayed for an unregistered user or registered unrecognized user is considered a not personalized view.

1.6. Content Viewer-Display Content (Personalized)

Content displayed to a registered recognized user is considered a personalized view of content. The content will be ordered in an order of most relevant to least relevant determined by relevancy factors such as discipline, CI and date.

1.7 Serve Not Search Engine

Serve not search engine uses the knowledge available about the user and information about the content to order the content in an order most relevant to the user details of which are given in sections below.

2. Serve Not Search Process Flow

The content such as static content available in but not limited to Tridion, 50lessons, Yellow Brix, Jive content are published in its own web server. Web server also contains the abstract and index information about the documents.

An unordered list of contents is programmatically derived based on the Index information of documents for recent items, related items, recommended items, Manpower 50lessons and Yellow Brix to the unregistered users as detailed in the diagram.

Serve not search is applied to provide information based on relevancy. The user will be provided information ordered from the most relevant to least relevant based on the knowledge the application has of the user.

Serve not search process flow and activity is explained in greater details as follows:

1. Assign Tags

This is the process of manually adding tags corresponding to the articles. The system administrator designate assigns the tags manually for the static content previously populated in Tridion.

2. Author Tag for Topics

The author assigns the tags manually for the topic user creates in Jive forum and blog. These tags are updated in Jive web server.

3. Publish

The articles present in the Tridion are published to system's web server.

4. Map Relevancy Items

This method extracts the tags from the abstract for the contents published in Web server. This method is used to map articles/other documents to predefined relevancy factors for those, which is pending to be mapped.

5. Populate Metadata

This method populates the metadata of information for the content in the different web servers to “serve not search” engine own data store. This process will look for updates in content repository and as a result updates the serve not search data store.

6. Mark Read

The content is marked as already read by “serve not search” engine to avoid a duplicate read.

7. Retrieve Metadata

This retrieves the metadata from Serve Not Search Engine's database when the user is browsing the system. This method retrieves the data, which will be later processed, and relevant information is shown to the user.

8. Filters and Sort

Filter and Sort is the process of identifying the most relevant article/document for listing in the system. It is retrieved from serve not Search engine data store based on relevancy as already detailed in the section above.

Relevance is identified based on the profession of user, Career Navigator results and the date. The system will display the list in the same order as delivered by the “Serve not search.

For unregistered users, the content listing is unordered or alternatively it means serve not search is not applicable. For such users this method provides information ordered in a non-personalized manner nevertheless it would still display lists for recent items, related items, and new items etc.

Registered users can browse the site without logging in. In this case, they are considered as unregistered users.

### VII. Job Board Integration Feature

The present inventive system also provides the user with the ability to view a XML job database where feeds from multiple job boards provide job information along with links back to the independent Web sites that are hosting these jobs. The “job watch” feature of the system will access the job database and recommend jobs to the user based on the user's profile information. When a job is select and the link is launched to the owning job site a mechanism is provided to pass a job ID so that that site can effect a more seamless user experience.

### VIII. Salary Comparison Feature

1.0 Salary Comparison—Current

1.1 Salary Comparison—Current

The user should be able to compare his/her current salary against that of the local average and national average. This should be presented to the user in a visual display showing the salary range in a graphic display. If the user has indicated a current salary in their profile, the site should provide a visual notification to the on he/she compares to the visual.

The Salary Comparison should take into consideration the following items
Job title, description, location

1.1.1 Salary Comparison—Other Jobs

A user should be able to investigate the salaries of other jobs by entering defined information. Once that information is entered, the user should be presented a salary range for the selected position with a high, low, and medium salary range.

In order to provide valuable information to the user, at a minimum the user should be able to define the following (there may be more based on solution provided):
A job title based on a list of job titles and relative descriptions
Job location
Company Size

The user through the course of completing their profile will enter some level of information. Should the user need to enter more information to perform the salary comparison, the system prompts the user to provide that information at that point. The user is not be redirected to another location within the site to enter needed data/information. Additionally, the user's profile data is used to populate the search criteria for the salary comparison on the current job. The user should not need to re-enter job information that was previously entered in the profile or uploaded through a resume.

### IX. Hot World of Work

The “hot world of work” feature of the present inventive system provides the user with current information about the world of work. The user can access this feature in multiple ways using the present inventive system, including:
1. Any registered user should have the option to view generalized Hot WOW content on their homepage (i.e., dashboard).
2. A registered user could be “served” personalize hot WOW content based on information in their profile (in the Articles and Resources and Community sections of system).
3. A registered user can choose to view more detailed information on the WOW that are relevant to his/her career or geography
   a. Users will provide account information (username and password)
   b. Once logged the user can navigate to a Hot WOW feature to go over information available.
   c. The user will be able to view the trends and drill down to details of the analysis, articles. The user will be able to view trends across user-defined criteria such as industry and/or geographies.

1. Communicate Trends and Patterns in the WOW

The system will tell the user about general trends in the world of work. This information will be communicated through various types of content (e.g., text based content assets, multimedia content assets on the changing WOW, dynamic content sources about WOW). Text assets will range from short articles about quarterly MEOS reports to custom articles on WOW. Dynamic content will include items such as WOW-related blogs on system, safe bridges to external blogs and site, RSS feeds, etc.

General information about hot WOW areas will be available on the registered homepage (i.e., dashboard) and in Articles and Resources and Community portions of the system.

2. Display Trends in Employment Markets Relevant to the System Users' Industry and Geographic Location.

System users shall have access to relevant employment trends. The system will display such data-driven information through a variety of charts and graphs. These charts may be static, e.g., pie charts showing demand for a particular job or profession, or may be dynamic, e.g., a Google Maps mashup.

3. Engage the System Community in Discussion Around WOW

The system enables users to participate in discussion of hot WOW areas.

4. Link WOW Information to Relevant Career/Job Opportunities for a System User

The system will create a summary of relevant job listings available in Direct Talent by combining three data sources: the user's profiles, data on hot WOW areas relevant to the user's location and/or industry, and job listings in Direct Talent. The user would be required to then access Direct Talent and apply for any jobs of interest.

### X. External Component Integration Feature

The present inventive system also provides a capability to integrate third party components and data that further enhance the career experience.

### XI. Career Leader

The Career leader is a service available as part of the present inventive system which is focused on profiling/assessing a person in terms of his professional abilities, motivation and career interest. This service and other similar assessment services will be available to all registered users of the system. Career Leader will be available through the system under the following titles:
Career Abilities Profile (CAP) will help an individual identify their top abilities in business work. The user can rate as many as 41 different abilities, which may have an impact on a person's career.
Career Motivation Profile (CMP) will help an individual prioritize what really is motivating to the person in their work. This can also help the individual work out the trade-offs the person will need to make in his career.
Career Themes Inventory (CTI) will help an individual discover their interests in business work. This is the most important of CAP, CMP and CTI as this forms the foundation of one's career.
Additional Career Assessments including but not limited to a 360 Review, Finding Your Right Industry, Finding the Right Job in the Right Company, etc.

Completion of these assessments provides valuation information that can be used by the system's knowledge engine to better serve information and connections. The ability to serve connections takes further advantage of unique algorithms based on completed assessments and delta match technology that is part of the Career Leader solution.

1. Career Assessment—Common for CAP, CMP and CTI

1.1.1 This service will be available to all registered users of the system.

1.1.2 Questions related to CAP, CMP and CTI are configurable for the following parameters:
Modifying the text of the existing questions
Sequence of the questions presented to the user

2. Career Abilities Profile—Assessment and Reporting

2.1 The user shall have the option of self-evaluation of their top abilities in business work.

2.2 Career ability is evaluated against the broad level attributes such as Problem Solving, Taking Initiative and Interpersonal Effectiveness. For the evaluations, the sub level attributes against each of the broad attributes are listed below.

2.2.1 Problem Solving: Creative Thinking, Critical Thinking, Quantitative Analysis, Quick Thinking, Strategic Thinking.

2.2.2 Taking Initiative: Action-orientation, Comfort with Risk, Day-to-Day Responsibility, Decisiveness, Delegating, Flexibility, Leadership, Multiple-focus, Persistence, Political Skill, Power-orientation, Recognition of Opportunity, Resilience, Time Management, Work Ethic.

2.2.3 Interpersonal Effectiveness: Ability to Compromise, Ability to Teach, Assertiveness, Comfort with Differences, Conflict Tolerance, Empathy Skills, Gaining Trust, Influence, Listening Skills, Merit-orientation, Motivational Ability, Openness to Criticism, Oral Communication, Organizational Priority, Projection of Confidence, Respect for Others, Self-control, Sensitivity and Tact, Sociability, Teamwork, Written Communication

2.3 Assessment Process—Self

2.3.1 Each sub level attribute is evaluated by collecting the response for a set of questions from the user.

2.3.2 Each question has seven responses for the respondent to choose

2.3.3 Rule for assessment test: The system shall mandate the user to answer all the questions before the user submits the test.

2.3.4 Scoring Algorithm: The system shall accept the user's self-rated response as is for each item.

2.3.5 Calculation of Response Style: Compare the sum of all 41 responses to some previously defined threshold level numbers, and provide a text comment based on whether the user's sum of all responses are

(a) Higher than the high-level threshold
Text based message is “Results indicate you responded to questions with a high level of optimism”

(b) Lower than the low-level threshold
Text based message is “Results indicate the user responded to questions with low level of optimism”

(c) In the middle of the two thresholds.
Text based message is “Results indicate you response were right level of optimism”

3. Career Motivation Profile—Assessment and Reports

3.1 User shall have the option of self-assessing and prioritizing their real motivators at work. It uses a relative assessment technique by comparing all previously defined motivating elements one against the other. It is then ranked based on the choices made by the user. The maximum the user goes for a motivating element accordingly points get accrued and finally determines the rank.

3.2 Career motivation profile is evaluated for the following motivation elements. The associated phrases used for evaluation is also listed along with
Affiliation: The position offers a setting with enjoyable colleagues with whom I feel a sense of belonging.
Altruism: The position offers the satisfaction of regularly helping others with their individual or business concerns.
Autonomy: The position offers considerable autonomy and independence.
Financial Gain: The position provides excellent opportunity for exceptional financial reward.
Intellectual Challenge: The position offers consistent intellectual challenge.
Lifestyle: The position allows ample time to pursue other important aspects of my lifestyle (family, leisure activities, etc.)
Managing People: The position offers the opportunity to manage and direct other people.
Positioning: The position offers experience and access to people and opportunities that will position me well for my next career move.
Power and Influence: The position offers the opportunity to exercise power and influence (to be an influential decision-maker).
Prestige: The position is with an organization that commands a great deal of prestige in its field.
Recognition: The position is in an environment where individual accomplishments are recognized with praise from peers and superiors.
Security: The position offers a great deal of security in terms of predictable salary, benefits, and future employment.
Variety: The position provides a great deal of variety in the nature of the work performed.

4. Career Themes Inventory

4.1 Career Themes Inventory will help an individual discover their interests in career themes from a previously defined list as given below

4.2 The official names for the Career Themes are:
Artistic Creativity
Community Service
Economic Research
Engineering and Science
Working with Equipment
Finance
Health Care Service
Mentoring and Organizational Development
Manufacturing Engineering
Managing in a High Customer Contact Environment
Managing in a Low Customer Contact Environment
Marketing and Advertising
New Product Development
Office and Administrative Work
Leadership in the Public Sector
Public Presentation
Risk and Adventure
Sales
Sports and Competition
Strategic Leadership
Leadership in Structured Environments
Teaching
Writing

5. Assessment Process

The assessment part consists of a Common Section and a Questionnaire Section.

Common section: This part of the assessment collects information from the user for Demographic Information, Nationality Information, Occupation information and Career Information. For further instruction on the section please refer “CareerThemesInventoryQuestionnaire.doc”.

Questionnaire section consists of 2 parts. Part 1: The first part consists of questions around work areas. The user can make choices as to how much the person would like this work from a scale of 0 to 3, 0 being the least and 3 being the greatest. Part 2: The second part consists of questions around activities. The user can make choices as to how much the person would like to engage in that activity from a scale 0 to 3, 0 being the least and 3 being the greatest.

### XII. Profile

There is information collected from the user in various screens and segments of the system and stored in one centralized location as part of the account so as to help the user manage it efficiently and to suit his/her preferences. This is part of account maintenance. Profile is a piece under account maintenance that describes the level of visibility of the user's account fields to others. The number of different profiles the user can choose to have depends on the different fields that (s)he would like to share with the different type of users. The system provides defaults for each profile and the user can override the system defaults.

The profile describes the visibility of selected items from account shared by the user to non-registered users, system users and his/her connections. The system recommends the default used in each profile and the user will be provided an option to override the system defaults. There will be 3 profiles to start with as detailed below:
Public profile
System profile
Connections profile that will include separate profiles to be exposed for mentor, mentee, and peers.

1. Profile Fields

The fields that constitute the profile information are collected at various locations as part of the user experience and management of the account information is provided at one location under account maintenance. The information collected from the user as part of account includes the following:
Identity—this includes first name, last name and display name
Personal demographics
Contact information
Photo(s)
CV/Resume
Interests etc.
Career Map
Career Leader outcomes
Career Navigator
Bookmarks
RSS
Community
   1. Peers
   2. Mentors
   3. Mentees
   4. Groups

2. Public Profile

This profile is available to all non-registered users and also displayed on any search engine result. The default fields that will be exposed as public to non-registered users and in search engine result are the identity and location of the user.

3. System Profile

This describes the profile that will be displayed to other system members. The defaults in this are the same as the public profile with the addition of messaging available for system users. The fields that can be exposed to system users based on settings the individual chooses include the following:
Identity
Personal Demographics
Contact Information
Photo(s)
CV/Resume
Interests
Community
Bookmarks
RSS

4. Connections Profile

The number of profiles under connections will depend on the connections that the user has. The user will be provided an option to have three different profiles based on the connections that includes a profile for mentor, mentee and peers. The fields that can be exposed to the community include:
Identity
Personal Demographics
Contact information
CV/Resume
Career Map
Groups
   XIII. Prompted Profile and Profile from Resume

1. Uploading a Resume

Functional Requirements:

To provide an optimal experience for the user, the registration, account building activities in the site are as short/simple as possible, this will help in reducing the amount of user abandonment.

As a user is building his/her profile within the system, they are presented with an option to upload their resume to expedite the process. The user is able to “browse” for a file a resume for addition to their profile. The resume should be parsed in such a way that the information contained is parsed into the related fields in the inventive system. For example, if a resume has a name, phone number, address, etc it should be parsed into the personal contact information section of the account. Once all of the information has been parsed, the user should is able to validate that the information entered in the fields was parsed/entered accurately. The user is also given the opportunity to edit, delete, and add to the information that was parsed.

If a user used the resume upload functionality, they are also allowed to enter information ad-hoc or manually into the account as well.

A user is able to upload multiple resumes. The process is to upload one and then validate and then allow for the upload of subsequent.

If there are multiple resumes that are being uploaded, the user is able to identify which information will be stored as the account information. If a resume is being uploaded at a later time after account information has been previously entered, the user is asked which information to continue to store in the account.

If a resume has been uploaded or if resume data has been entered manually it is stored in the system for future use. Future use may consist of (but not limited to) mining the info for the system administrator's benefit in research, population into other features of the system, use in connecting people based on similarities, etc.

The data should also populate the knowledge engine for use by other features and subroutines for the system where by all user's data can be aggregated, evaluated and analyzed to identify career paths, connect people, show multiple paths, etc.

Resumes are accepted in the following formats .doc, .rtf, pdf, and txt, and all equivalent, manipulatable, text-based formats.

2. Prompted Profiling

Functional Requirements:

To ensure the registered user base continue to grow and expand, the registration process within the system has been made very simple and does not require a large amount of information. Therefore, there will be many cases where the user will need to provide additional information to the site in order to get the benefit of certain functionality.

The user is prompted visually throughout the site to entice them to enter/fill out more information in their profile. The user is given some indication of how complete their profile is and what can be gained by completing remaining parts of the profile.

Should a user need to provide additional information, the user is prompted for that information throughout the site. The user is either prompted at their current location to enter that info and the info should be stored and updated in their account accordingly or the user is taken to the location to enter the information but then returned back to the function they were do.

If a user was trying to perform or use a certain piece of functionality, that feature should be completed and presented to the user after he/she has entered the necessary information rather than the user having to indicate in the system again.

### XIV. Protect Sire Data Integrity and Privacy

1. Data Privacy

The present inventive system will have a Data Privacy policy published within the site that requires the consent of individuals registering to use the system.

Data Privacy policy is always one click away from user.

The Data Privacy policy is available for review and accepted during the registration process.

When the Privacy Notice is requested for consent and optional review, it is to be available for display and is to be consented to before significant Private Information (PI) is collected.

2. Terms of Use

The inventive system has a Terms of Use published within the site and requires the consent of individuals registering to use the system. Terms of Use are always one click away from user.

Terms of Use must be available for review and accepted during the registration process. User is required to accept the Terms of Use notice prior to registering to use the system.

When the Terms of Use is requested for consent and optional review, it is to be available for display and is to be consented to before significant Private Information (PI) is collected.

3. Security and Governance

When collecting Private Information (PI), a secure form of transmission is used. Prior to becoming a registered user of the system, a confirmation email is sent to the individual to confirm that he/she has actually requested the service. When the individual confirms this, the registration is activated.

### XV. Social Networking/Community

The Social Networking/Community feature is implemented such that the users will have as much of a seamless user experience as possible regardless of the location within the present inventive system. For example, a user will have a similar experience viewing content such as articles, etc. to when the user is reading and responding to a blog or forum. The user will also have the ability to rate and tag content in throughout the site and see how others are viewing and rating the same content. This functionality will drive a number of features that will be served in the site, one of which is the knowledge engine which will drive connections (peers, mentors, mentees), search, serving of content. The Social Networking software used with the present inventive system is Jive Clearspace 2.5.

The Social Networking functionality operates in accordance with the following parameters:
Unregistered users can connect to the social networking features of the system and view information in a read-only format.
Users must be registered on the system to actively participate in the social networking features (i.e. blogs, forums, user groups, etc.).
The user will have the ability to take action from any items in the tool bar or footer throughout the entire experience. If certain functions are available in parts of the site outside of Community, those same functions should be available in “Community”

The Social Networking business requirements are as follows:
Groups (ad-hoc and dynamic) Functionality that enables users to create groups/communities based on special topics. Users must be invited to participate in a group/community.
Blogs Blogs in the system are open to both registered and non-registered users. Users must be registered with the system to comment or rate a Blog. Blogs are moderated by the system administrator.
Discussion Forums Forums in the Community area of the system will be open to everyone and moderated by Manpower. Users must be registered users of the system to participate in a discussion thread.
Wiki's
User Generated Content
User Profiles Information that the user has provided about them that can be used to connect users together (through friending and mentoring) and can be used to serve up content. The more information the system collects about a user in the user profile, the more intelligent the knowledge engine will be and the greater the ability to provide additional value to the user.
Invite a Friend The ability for a user to send out an invitation to system and non-system user to invite them to join the system itself, become a member of group, or participates in a blog or forum.
Send to a Friend The ability for a user to send content (i.e. article, blog, video, etc.) to a friend that is either a system user or a non-system user.
User Tagging The ability for a user to tag a piece of content (i.e. article, blog, video, etc.) with a tag or keyword.
Rating (users and content) The ability for a user to rate a piece of content (i.e. article, blog, video, etc.) on a scale of 1-5.
Searching The ability for registered users to search for other registered users that have made their profiles public. In addition, users can also search for content associated with the system (blogs, forums, etc.)
Rewards and Recognition Recognizing and reward registered users that are actively participating in system forums, blog, groups, etc.
Instant Messaging Instant Messaging (IM) is a form of real-time communication between two or more people based on typed text. The text is conveyed via computers connected over a network such as the Internet.

### XVI. Channels for Feedback/User Submitted Content for Consideration

The FEEDBACK functionality operates within the following parameters:
Any user (registered or non-registered) is able to provide feedback.
An operational will establish rules for responding to and addressing the feedback.
The users will be shown a confirmation that their feedback has been submitted.

1. Channels for Site Feedback

Functional Requirements

Users have the ability to provide feedback to the system administrator about the system. This feedback is provided through the system and should be available to all user types (registered and non-registered).

The feedback functionality is present throughout the whole site consistently, for example a “Contact Us”, in the header of the site. By clicking on the header or link, the user will be taken to a 1-Step (page) Submission Page. The page allows for the user to enter a “reason” for the feedback. The user will be presented with the ability to enter the following each step noted below will be required unless otherwise stated.
1. Type of Feedback:
   Ask a Question
   Send a Comment/Tell you my Views
   Make a Suggestion for site Content
   Report a Technical Issue
2. Subject
3. Comments
4. Name
5. Email Address
6. Phone Number: Optional

The user once he/she has entered information in the fields noted above should be presented with a “submit” function and a confirmation of their submission being accepted.

2. Directing of Feedback

All feedback submitted by users is directed to an email box for an operational owner associated with the system administrator to review and respond to. The emails are identified based on the “Type” of feedback being presented. For example, if user submitted feedback in the type “Report a Technical Issue” the email should call that out in some way for visibility to the site monitor as some issues reported may be directed to others or the email box may be monitored by multiple people who are responsible for certain “types” submitted.

### XVII. Guided Help and FAQs Functionality

1. Help Link

A Help link is available on all screens within the system. The link redirects users to the support functionality.

2. Self-Service Support Functionality

In one variation of the present inventive system, upon clicking the Help link, a list of FAQs shall display which detail all of the main features of the site such as account maintenance and functionality, how to use the career assessments, and the general privacy policy. FAQs are categorized by content. Links to specific areas of content at the system are provided. For example, a link at the top of the page named How do I create an account? would redirect users to the information on the page relating to account creation.

If the list of FAQs is significant enough, users shall be presented with a means to easily return to the list of categories or questions without having to scroll or use their browser back button. The FAQs in this variation will be displayed in a standard question and answer format. For example:
How will my personal information be used? General information about users may be collected to deliver a more personalized and relevant experience, but we will never share specific, personal information about you with a third party without your permission.

Users will have the ability to comment on the usefulness of the FAQs by answering one question for the entire list of FAQs. The question may be in the form of a yes/no or Likert scale, but the question will survey users how useful and/or relevant they feel the FAQs were to their needs. Information on how to contact system administrator support staff is provided on the FAQ page.

3. Live Support

A link to live support is present on the FAQ/help page. This directs users to the general Contact Us page. The Contact Us page allows for a support question category in the contact reason drop-down. Emails received through the Contact Us live support are tracked so that the FAQ page can be expanded to cover common questions sent to live support that are not already addressed in the FAQs.

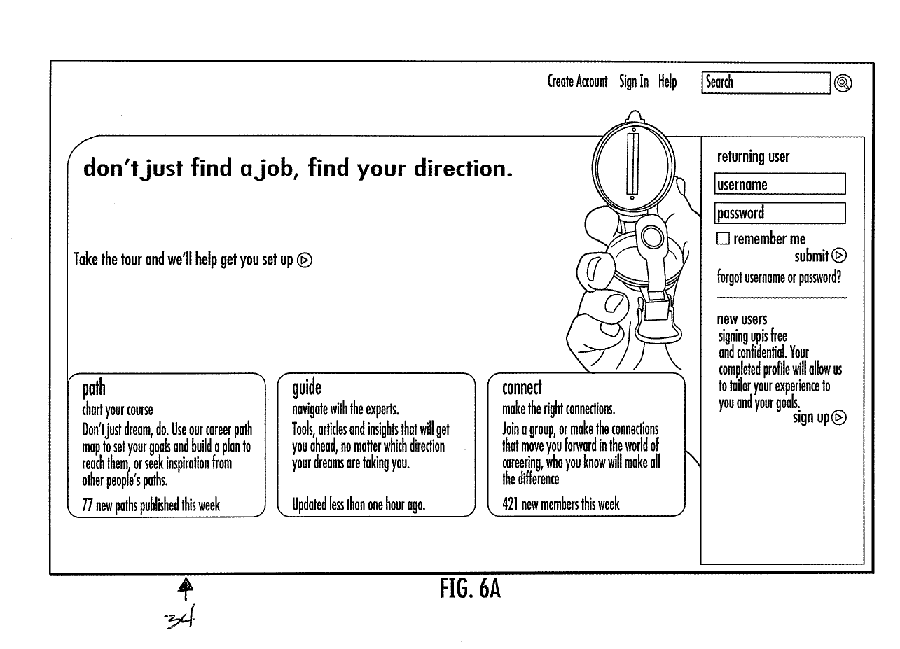

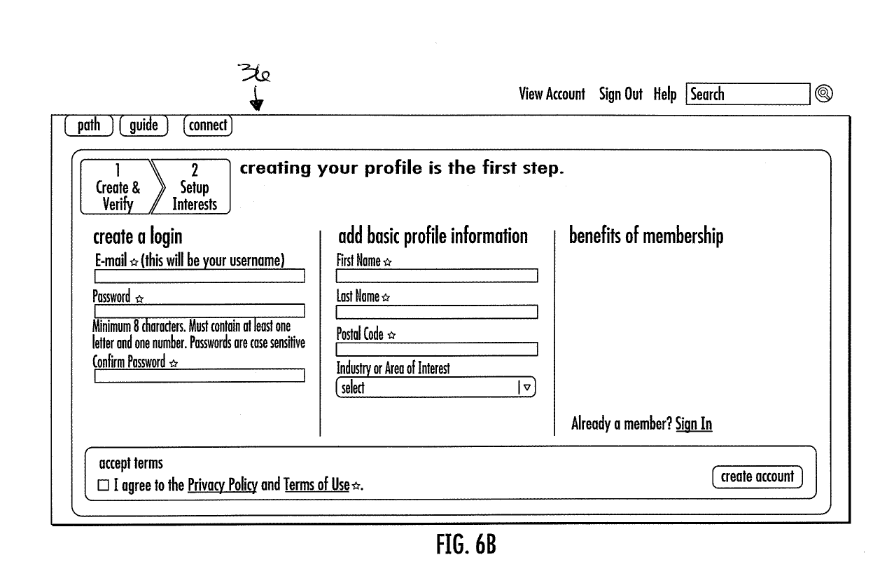

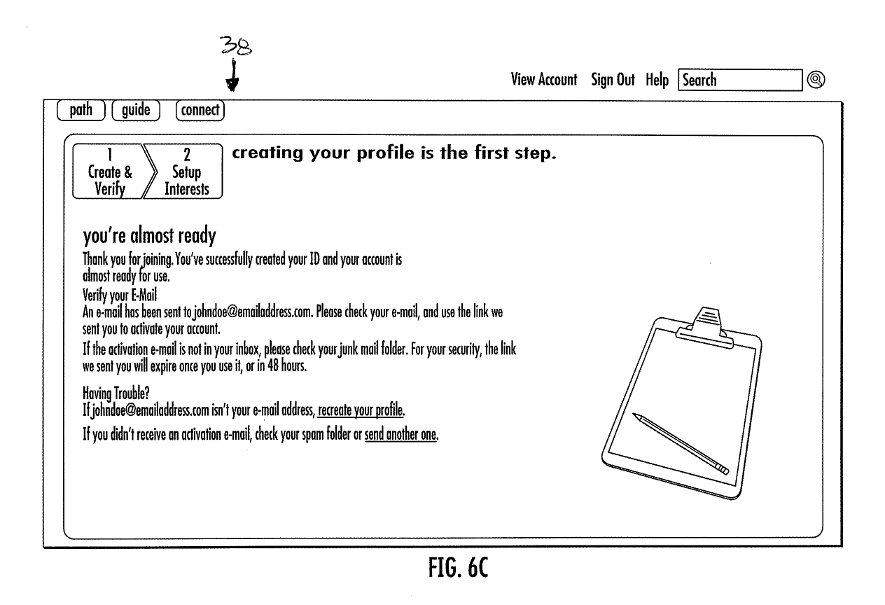

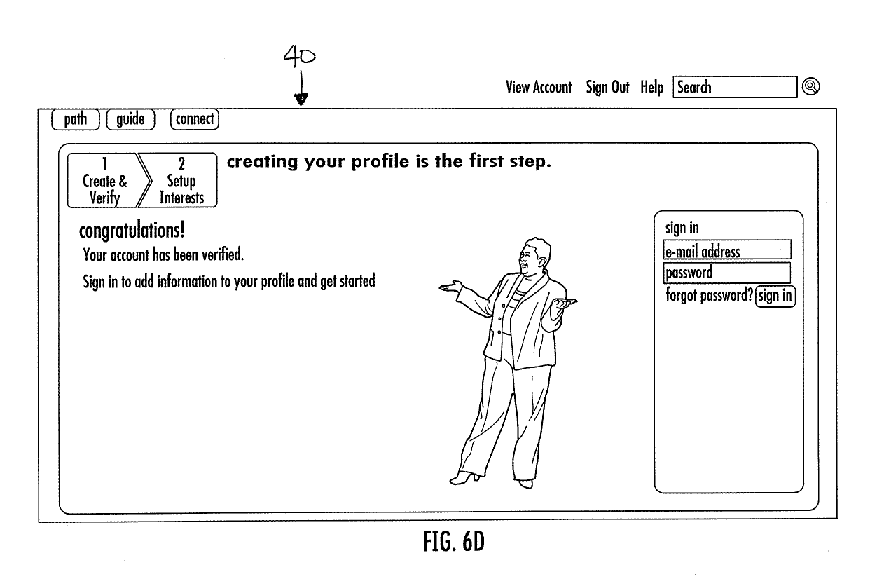

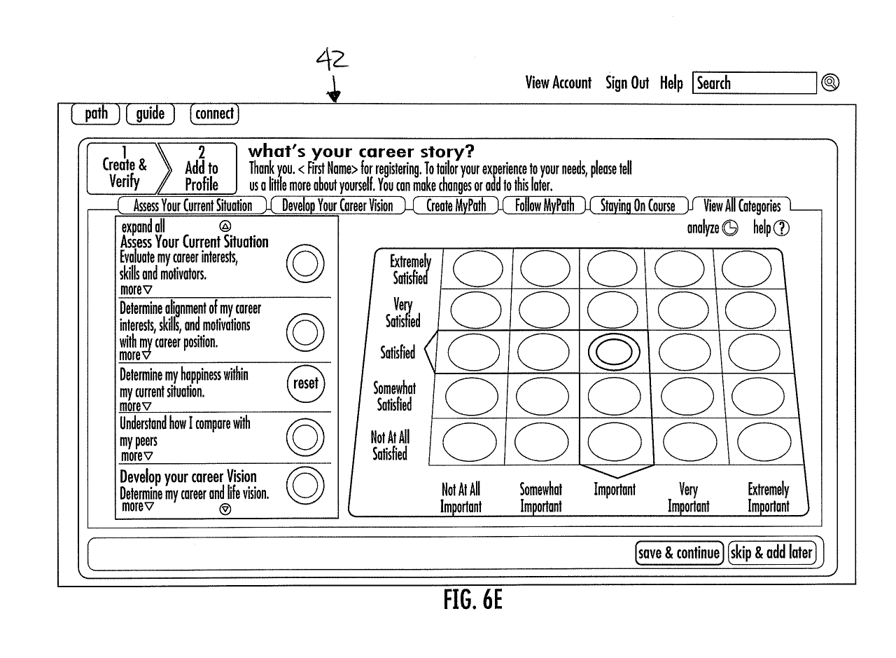

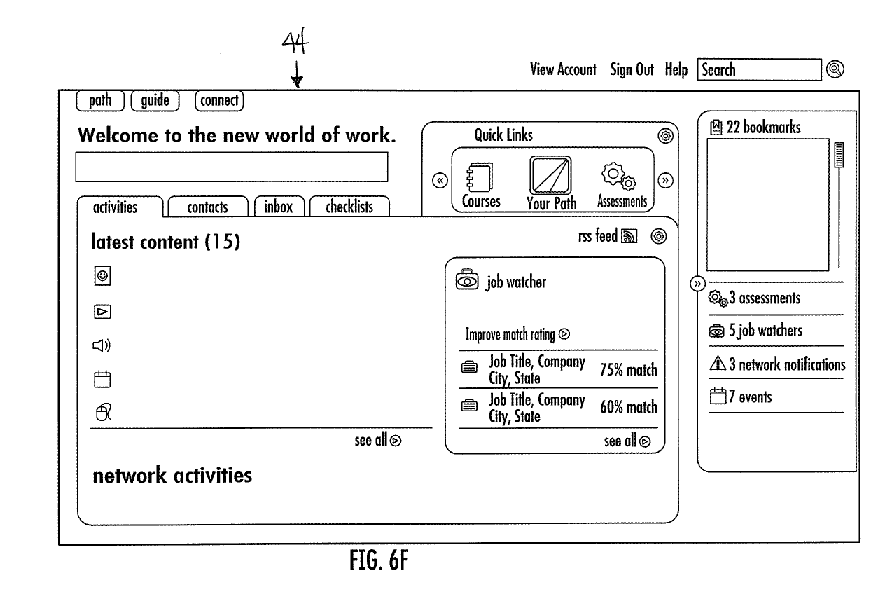

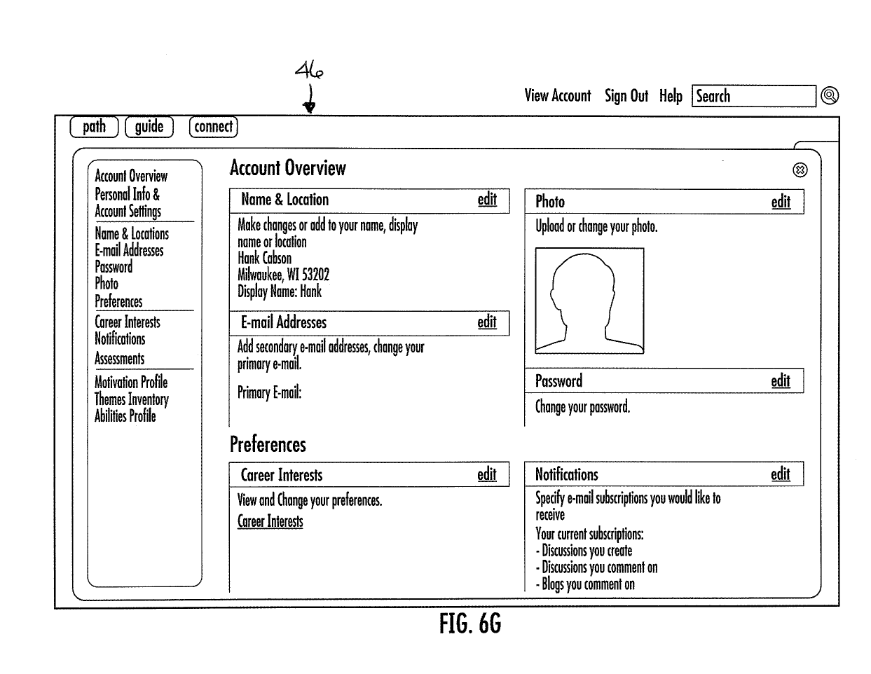

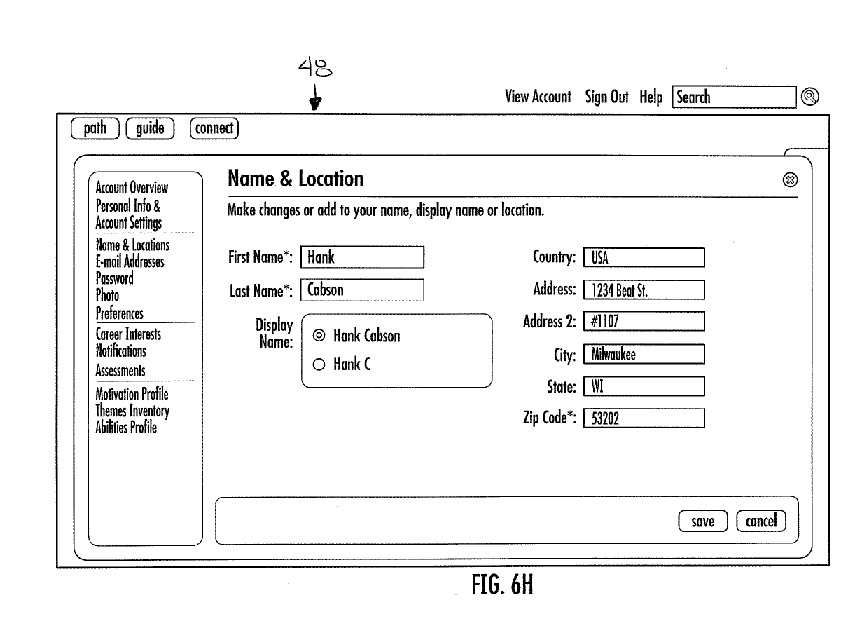

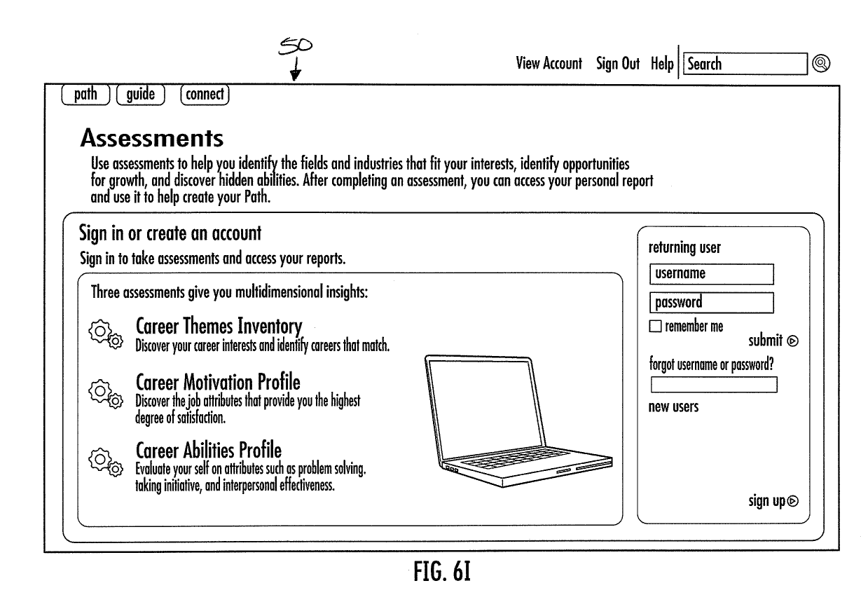

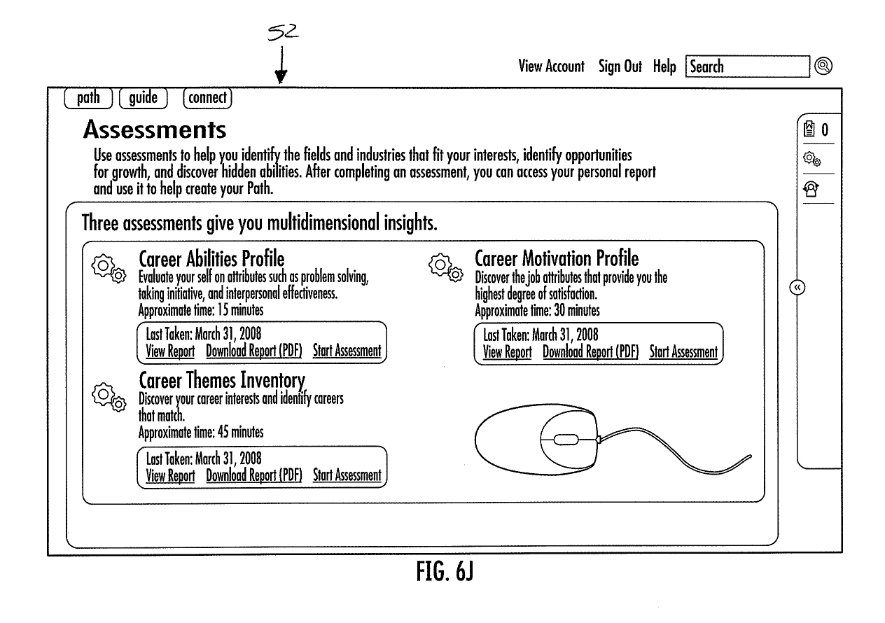

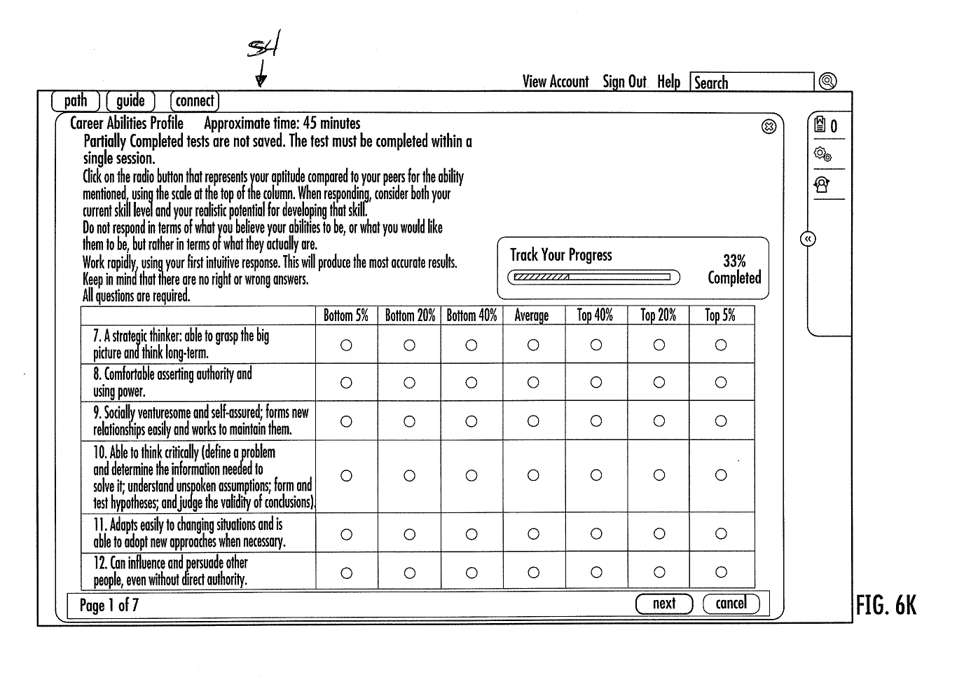

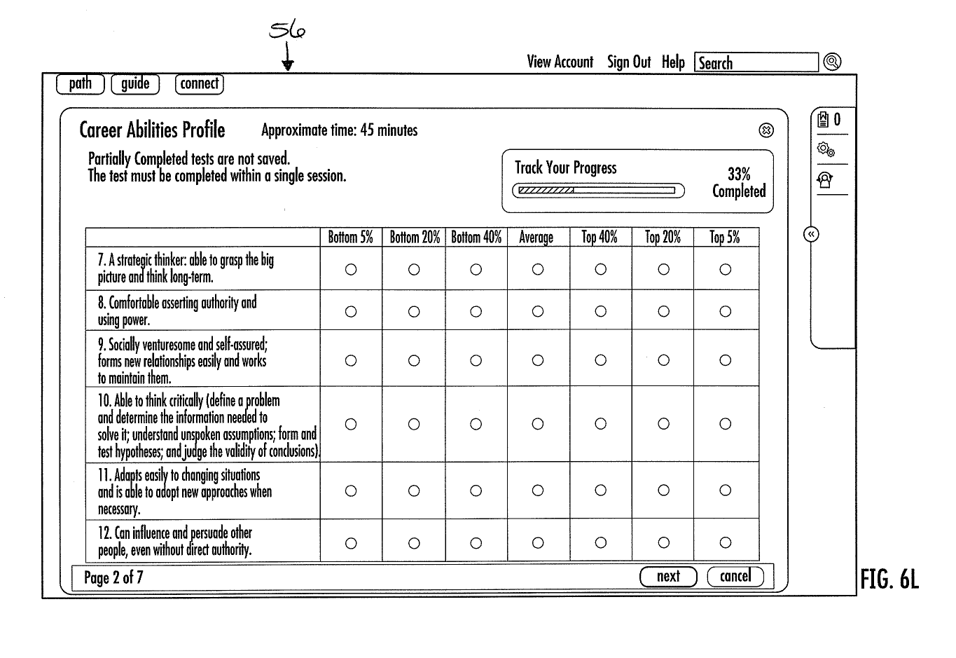

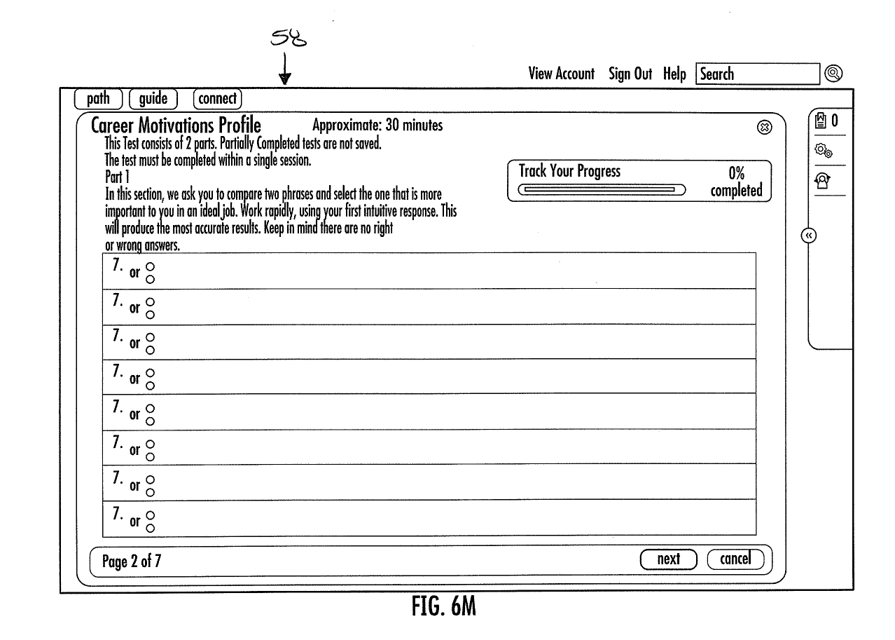

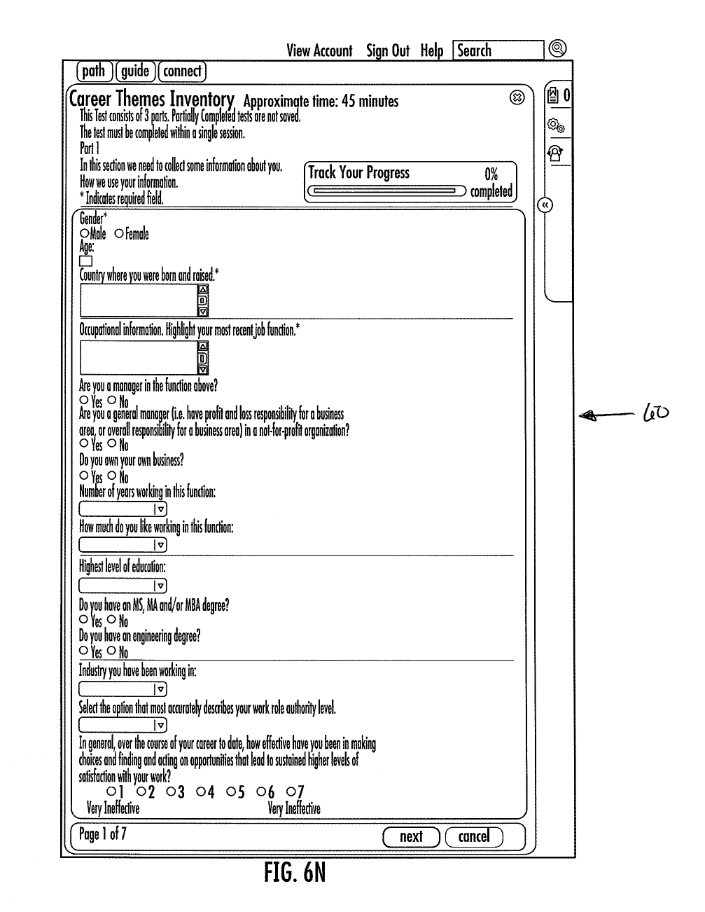

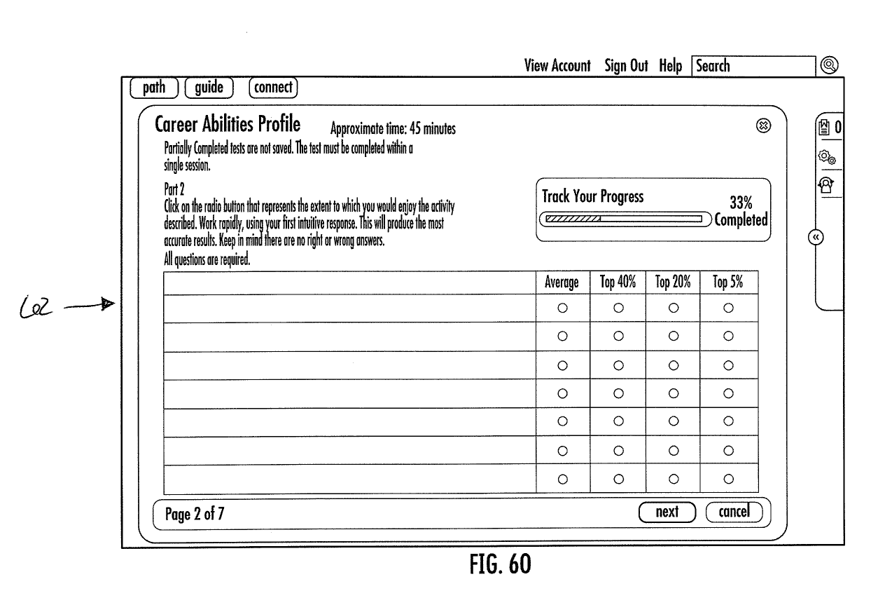

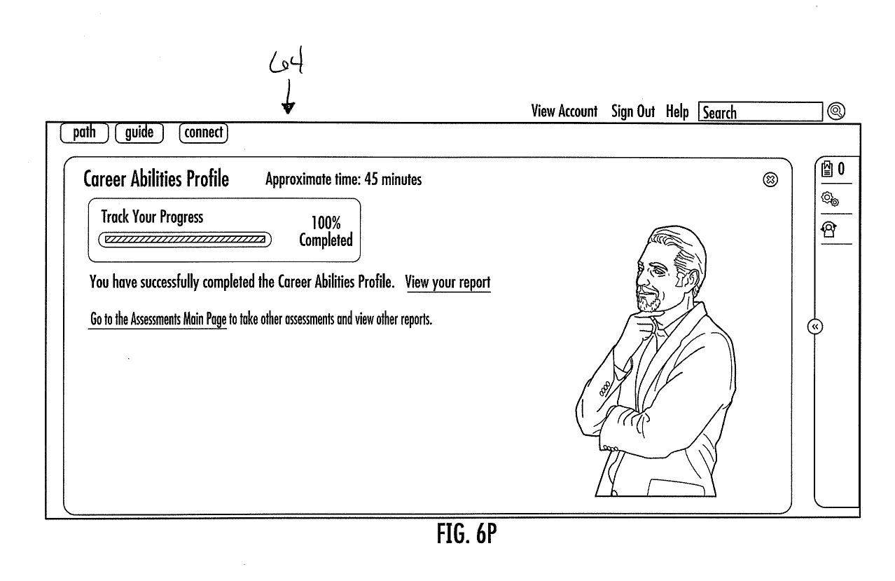

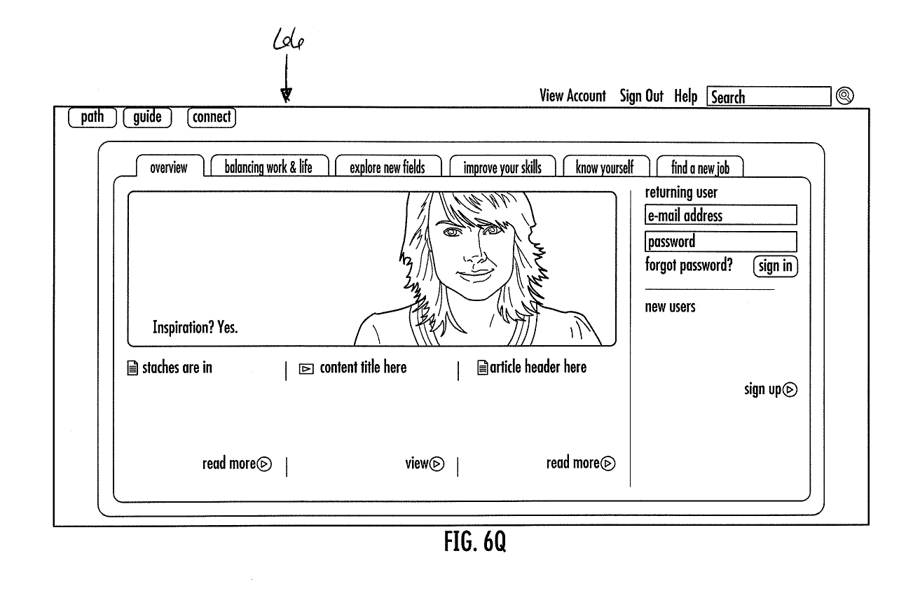

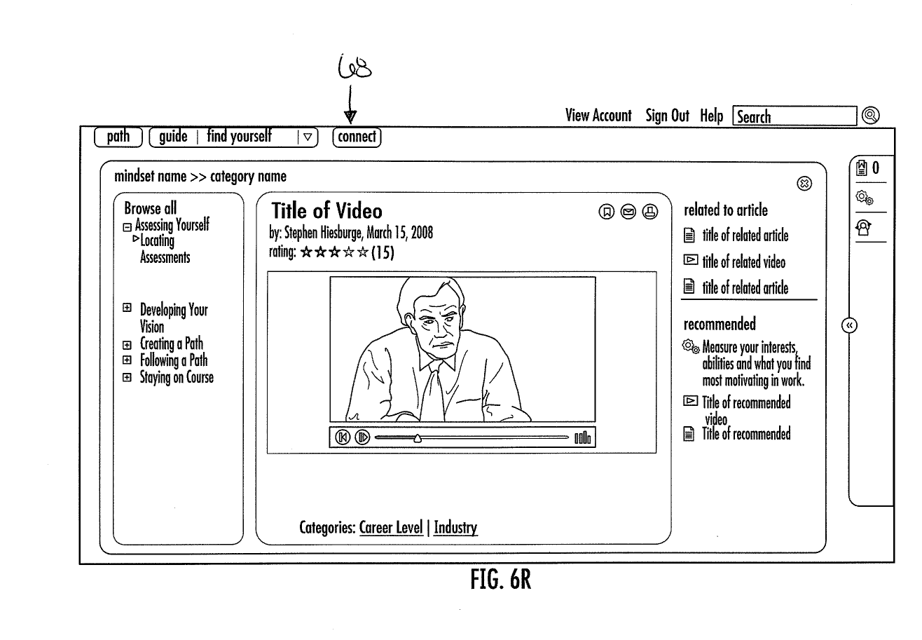

FIGS. 6(a)-(r) show a series of exemplary screen shots 34-68 of the present inventive career management system.

While the present invention has been described in connection with a specific application, this application is exemplary in nature and is not intended to be limiting on the possible applications of this invention. It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

We claim:

1. A career management system comprising a module enabling the user of the system to prepare a career profile and comprising a processor enabling the system to learn and provide targeted information to the user and to link the user with other users and user groups.

2. The career management system of claim 1 wherein the system is software-based.

3. The career management system of claim 1 wherein the system enables the user to communicate with the system and with other users via a computer network.

4. A computer-software based career management system comprising a module for collecting information from the user to prepare a career profile and comprising a module for enabling the system to learn about the user and provide targeted information to the user and to link the user with other users and user groups.

5. The career management system of claim 4 wherein the system is software-based.

6. The career management system of claim 4 wherein the system enables the user to communicate with the system and with other users via a computer network.

7. A career management system comprising: a module enabling a user to enter a first data set comprising career information, educational background, personal preferences, a module for storing a second data set comprising information pertaining to a plurality of careers and jobs, a processor for comparing information in the first data set against information in the second data and preparing output in the form of a career map.

8. The career management system of claim 7 wherein the system is software-based.

9. The career management system of claim 7 wherein the system enables the user to communicate with the system and with other users via a computer network.
